(19) United States
(12) Patent Application Publication
(10) Pub. No.: US 2010/0128353 A1
(43) Pub. Date: May 27, 2010

(54) IMAGING OPTICAL SYSTEM, IMAGE READING APPARATUS AND IMAGE READING APPARATUS USING THE IMAGING OPTICAL SYSTEM

(75) Inventors: Hideshi Nagata, Tokyo (JP); Kenjiro Hamanaka, Tokyo (JP); Hiroyuki Nemoto, Tokyo (JP)

Correspondence Address: RATNERPRESTIA, P.O. BOX 980, VALLEY FORGE, PA, 19482, US

(73) Assignee: NIPPON SHEET GLASS COMPANY, LIMITED, Tokyo (JP)

(21) Appl. No.: 12/089,311

(22) PCT Filed: Oct. 4, 2006
(86) PCT No.: PCT/JP2006/319875

§ 371 Date: Apr. 4, 2008

(30) Foreign Application Priority Data
Oct. 6, 2005 (JP) 2005293286

(51) Int. Cl. G02B 27/12

(52) U.S. Cl. 359/619

(57) ABSTRACT

An imaging optical system a high quality image may be implemented by determining the optimum design conditions for suppressing the generation of ghost while holding uniform and sufficient light using a simulation method. In the imaging optical system having a slit, the requirements for removing the stray light are the inclination of a lens arrangement direction, the slit width, the lens pitch, the view angle, and the height of the light-shielding wall. The slit location, the lens thickness, and the lens row width do not affect the stray light removal, but affect the brightness. In the imaging optical system having no slit, the essential requirements for removing the stray light are the height of the light-shielding wall and the lens pitch. The lens thickness and the lens row width do not affect the stray light removal, but affect the brightness.

### TECHNICAL FIELD

The present invention relates to an imaging optical system to transfer an image to a linear imaging area using a resin erected lens array, and an image reading apparatus and an image writing apparatus using the imaging optical system.

### BACKGROUND ART

An imaging optical system comprises an optical source, a lens, a sensor array (CCD etc.), and a case (housing) for accommodating these components as described in Japanese Patent Publication No. 167778/1993.

An imaging optical system used in an image reading apparatus has a structure for irradiating an original by the light outputted from an light source, collecting the light reflected on the original by a lens, and acquiring the collected light by a sensor array. When the light reflected from the original is inputted into the lens to be acquired by the sensor array, flare and ghost may be generated depending on the structure of an optical system, resulting in the decrease of an image quality.

In order to prevent the generation of flare and ghost, it is important that the locations of components constituting an imaging optical system such as an optical source, a lens, and a sensor array are regulated. For example, the publication described above discloses that s slit is arranged between the lens and the sensor array so that stray light is not incident on the a sensor array.

As a lens constituting an image reading apparatus, a rod-lens array has been conventionally used, which is disclosed in the publication described above. A rod-lens array is an array of rod-lenses arranged in parallel, so that the rod-lens array has a structure such that the incident light proceeds in respective rod-lenses without being incident into the neighbored rod-lenses. As a result, in case that a rod-lens array is used, flare and ghost is not substantially be generated. However, in order to realize a higher quality image, the structure is generally adopted such that undesired light does not proceed into the neighbored rod-lenses by providing respective rod-lenses with a flare-cutting member or a light-shielding film.

In recent days, an image reading apparatus has been developing such that a planar lens array plate is used in place of a rod-lens array. A lens array plate is integrally fabricated by an injection molding of resin, so that a light-shielding film may not be formed among lenses during manufacturing. Also, respective lenses in a planar lens array plate are not insulated as in rod-lenses, so that the undesired light easily proceeds into among lenses in the lens array plate. Therefore, the generation of flare and ghost may become a major issue when a lens array plate is used, which is not a major issue when a rod-lens array is used.

In order to prevent the generation of ghost, generally used are the method for providing a light-shielding film on a lens array plate, or the method for providing a slit between an original and a lens array plate (see Japanese Patent Publication No. 202411/2003).

Also, Japanese Patent Publication No. 292739/2000 discloses a lens array plate in which the diameter of a lens on output side is greater than that of a lens on input side in order to obtain a more bright image in case that a plurality of lens array plates are stacked.

### DISCLOSURE OF THE PRESENT INVENTION

### Problems to be Solved

In order to prevent the generation of ghost, a slit is provided between a lens array plate and a sensor array substrate, a slit is provided between an original and a lens array plate, or a light-shielding wall which absorbs the light is provided on a lens array plate as described above. However, if a slit, a lens array plate, a sensor array, and the like are not subjected to an accurate location adjustment, a problem such that ghost may not be prevented occurs.

In order to prevent the generation of ghost, many factors should be considered such as the width of a slit, the location of a slit, the aperture angle of a lens, the width of a lens forming area, the thickness of a lens array plate, a lens pitch, the height of a light-shielding wall, the forming location of a light-shielding wall (a light-shielding wall is formed on which of the front or back surface of a lens array plate, a light-shielding wall is formed outside or on a lens array plate, or is embedded inside or in a lens array plate), an optical absorptance, the surface roughness of a light-shielding wall, and the like. It is noted that each of these factors does not independently contribute to the prevention of ghost, but respective factors contribute to the prevention of ghost in association with each other. For example, if the aperture angle of a lens is different, the most preferable width of a slit becomes different. Therefore, it is very difficult to find out the optimum conditions for all of the factors, and then the design values by which ghost is least generated are conventionally determined by roughly varying one or two parameters of the factors such as the width of a slit, the location of a slit, and the like with the parameters of certain factors such as the aperture angle of a lens, the width of a lens forming area, the height of a light-shielding wall, and so on being fixed to arbitrary values, for example.

However, in the conventional method described above, while the optimum conditions for the width of a slit may be determined, the optimum conditions for factors other than the width of a slit may not be determined, so that the imaging optical system has not been provided, in which all of the factors have been designed to the optimum conditions for preventing the generation of ghost.

Furthermore, when the optimum design is implemented for a certain view angle, it is required to determine the optimum design value every view angles. If the design values for factors by which ghost is not generated is provided independently of view angle, the manufacturing process may be simplified in case that the lens array plates having different view angles are manufactured, because a light-shielding wall, a slit, and the like are fabricated based on the same design values.

In case of an imaging optical system comprising a slit, a location adjustment between a slit and a sensor array is required in a manufacturing process. If all of ghost are prevented without using a slit, the manufacturing process may be further simplified and the size of an imaging optical system may be smaller.

Herein, the meaning of “ghost is not generated” includes both cases, i.e., ghost is not quite generated and ghost is generated in a small degree such that the generated ghost may be removed by an image processing. In case of an imaging optical system in which ghost is not quite generated, an image processing is not required so that the reading or writing rate of an image reading or writing apparatus may be fast.

In an imaging optical system, it is required for a high quality image that ghost is not generated, but also the amount of light is large and even. In an image reading apparatus and image writing apparatus of personal use, even if ghost is generated, the ghost will not be remarkable when the amount of light is small, so that the generation of some degree of ghost is permitted. However, a high quality image is required in an image reading apparatus or an image writing apparatus of business use, so that it is required that ghost is not generated, the amount of light is large, and the unevenness of the amount of light does not occur.

The object of the present is, therefore, to provide an imaging optical system in which a high quality image may be implemented by determining the optimum design conditions for suppressing the generation of ghost while holding even and enough amount of light using a simulation method.

Another object of the present is to provide an image reading apparatus and an image writing apparatus using such an imaging optical system.

### Means for Solving the Problems

The present invention is an imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that the lens arrangement direction of the lens array is different from the direction of the longitudinal edge of the lens forming area of the lens array.

Also, the present invention is an imaging optical system comprising an object plane, a lens array for transmitting the light from the object plane, an image reading plane or an image writing plane arranged at an imaging position of the light transmitted through the lens array, and a light-shielding wall provided at the lens array, characterized in that the value of e=(h/DM)×tan θ×(P/1.25D) is of 0<e, wherein P is a lens pitch of the lens array, D is the lens diameter of an inner lens of the lens array, and DL is the lens diameter of an outer lens of the lens array, h is the height of the light-shielding wall, and DM=(DL+D)/2.

Also, the present invention is an image reading apparatus and an image writing apparatus each comprising the imaging optical system described above.

According to the present invention, the imaging optical system may be presented in which ghost is suppressed in such a degree that the image quality is not affected. Furthermore, according to the present invention, the imaging optical system may be presented in which the brightness is high and the unevenness of the amount of light is small.

According to the present invention, the relationships among the design values for the light-shielding wall, the slit, etc. affecting the ghost removal and the amount of light are represented by formulae, and the optimum conditions for the formulae are determined. Therefore, the optimum design values for the imaging optical system may easily be determined, so that the design variation of the imaging optical system may be readily conducted.

### BRIEF DESCRIPTION OF DRAWINGS

FIG. 1 is a schematic view showing a fundamental structure of an imaging optical system.

FIG. 2 is a schematic view showing a hexagonal arrangement of lenses.

FIG. 3 is a schematic view showing a square arrangement of lenses.

FIG. 4A is a schematic view showing lens arrangement in an arbitrary direction.

FIG. 4B is a schematic view showing lens arrangement in an arbitrary direction.

FIG. 4C is a schematic view showing lens arrangement in an arbitrary direction.

FIG. 5A is a schematic view showing an arbitrary square arrangement of lenses.

FIG. 5B is a schematic view showing an arbitrary square arrangement of lenses.

FIG. 5C is a schematic view showing an arbitrary square arrangement of lenses.

FIG. 6A is a schematic view showing an arbitrary shape of lens aperture.

FIG. 6B is a schematic view showing an arbitrary shape of lens aperture.

FIG. 6C is a schematic view showing an arbitrary shape of lens aperture.

FIG. 6D is a schematic view showing an arbitrary shape of lens aperture.

FIG. 6E is a schematic view showing an arbitrary shape of lens aperture.

FIG. 7 is a schematic view showing the stray light removal by means of a light-shielding wall.

FIG. 8 is a schematic view showing an inside-formed light-shielding wall.

FIG. 9 is a schematic view showing the stray light removal by means of a light-shielding wall (provided on the side of an image reading plane or an image writing plane).

FIG. 10 is a schematic view showing the stray light removal by means of a light-shielding wall (provided on both sides of a lens array).

FIG. 11 is a schematic view showing the inclination of lens arrangement direction.

FIG. 12 is a schematic view showing the most preferable inclined angle Φ of lens arrangement direction.

FIG. 13 is a schematic view showing a view angle θ indicating the inclination of main light ray.

FIG. 14 is a schematic view showing the size of the width of a slit projected on the lens surface.

FIG. 15 is a schematic view illustrating the definition of a lens row width.

FIG. 16 is a schematic view showing the size of the light ray of a view angle θ projected on the lens surface from an image point to be read.

FIG. 17 is a schematic view showing the relationship between the diameter DL of an outer lens and the diameter D of an inner lens.

FIG. 18 is a schematic view showing the condition such that the lens diameter DL of an outer lens is larger in a concentric fashion than the lens diameter D of an inner lens.

FIG. 19 is a schematic view showing the condition such that the aperture of an inner lens is made smaller in a main-scanning direction.

FIG. 20 is a schematic view showing the condition such that two lens array plates are shifted to each other in a main- scanning direction.

FIG. 21 is a schematic view showing the condition such that the lens diameter is varied only in a main-scanning direction.

FIG. 22A is a schematic view showing the condition such that the lens array plate is mounted in a high accuracy.

FIG. 22B is a schematic view showing the condition such that the lens array plate is mounted in an inclined manner.

FIG. 23 is a schematic view showing the condition such that the irradiating light from a light source is kicked by the end portion of the lens array plate.

FIG. 24 is a schematic view showing the condition such that the kicking of the irradiating light may be reduced by providing the lens forming area on the lens array plate at the side near to the light source.

FIG. 25 is a schematic view showing the condition such that the kicking of the irradiating light may be reduced by cutting off both edges of the lens array plate.

FIG. 26 is a schematic view showing an arbitrary shape of lens aperture.

FIG. 27 is a schematic view showing the stray light removal by means of a light-shielding wall.

FIG. 28 is a schematic view showing an inside-formed light-shielding wall.

FIG. 29 is a schematic view showing the stray light removal by means of a light-shielding wall (provided on the side of an image reading plane or an image writing plane).

FIG. 30 is a schematic view showing the calculation model by a ray tracing method.

FIG. 31 is a schematic view showing the relationship between a view angle θ and a stray light generating point.

FIG. 32 is a schematic view illustrating how the light ray is generated from a stray light generating point based on a view angle θ of the resin lens array.

FIG. 33 is a schematic view showing the relationship between the distance from an image point to be read to a stray light generating point at an inclined angle of 15° and the width required for removing the stray light.

FIG. 34 is a schematic view showing the slit width required for removing the stray light.

FIG. 35 is a schematic view showing the relationship between the imaging light ray and the slit width.

FIG. 36 is a schematic view showing the relationship between the imaging light ray and the slit width.

FIG. 37 is a schematic view showing an image reading apparatus.

FIG. 38 is a schematic view showing an image writing apparatus.

### BEST MODE FOR CARRYING OUT THE INVENTION

(Explanation for an Imaging Optical System, an Image Reading Apparatus, and an Image Writing Apparatus)

An imaging optical system used for an image reading apparatus such as an image scanner, a copy machine, or the like comprises an object plane, a lens array for transmitting the light from the object plane, and a sensor array (a photoelectric conversion element) arranged at an imaging position of the light transmitted through the lens array.

An imaging optical system used for an image writing apparatus such as a laser printer comprises an object plane, a lens array for transmitting the light from the object plane, and an image writing plane (a photosensitive drum) arranged at an imaging position of the light transmitted through the lens array.

An image reading apparatus is composed of an imaging optical system, an original plate such as an original glass plate, and an irradiating apparatus which are integrally accommodated in a housing. An image writing apparatus is composed of an imaging optical system, an original plate such as an original glass plate, a toner bottle, and an irradiating apparatus which are integrally accommodated in a housing. a toner bottle, a photosensitive drum, and a light-emitting element array which are integrally accommodated in a housing.

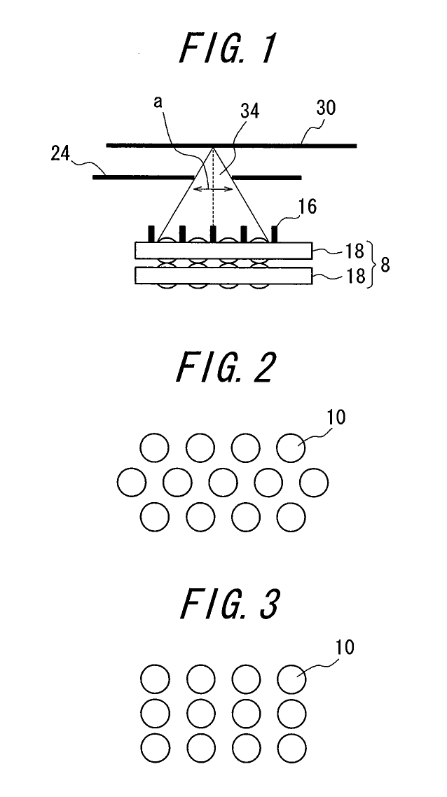

Referring to FIG. 1, there is shown a fundamental structure of an imaging optical system in accordance with the present invention. The imaging optical system comprises an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array.

In FIG. 1, there is shown one example of the imaging optical system. The lens array 8 is composed of at least two stacked lens array plates 18 on which the light-shielding wall 16 is formed. The slit 24 is provided between the object plane 30 and the lens array 8. The slit 24 includes an opening 34 having the width a. The longitudinal direction of the opening extends in parallel with the main-scanning direction.

There are a reductive magnification system and an unit magnification system in the imaging optical system. A lens array used in the unit magnification system is an erected unit magnification lens array which is composed of at least two stacked lens array plates made of glass or resin. A reductive magnification optical system is composed of at least one lens array plate.

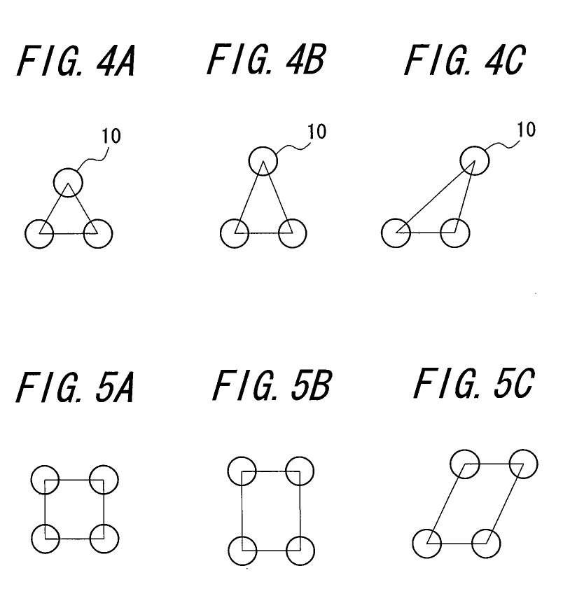

On at least one surface of the lens array plate, spherical or aspherical convex microlenses are regularly arrayed in two dimension by predetermined lens pitch. Two dimensional arrangement of microlenses may be any arrangement such as hexagonal arrangement shown in FIG. 2 or square arrangement shown in FIG. 3. In the figures, reference numeral 10 designates a convex microlens. In case of hexagonal arrangement, the shape formed by lines connecting the centers of lens apertures may be any triangle such as an equilateral triangle, an sosceles triangle, or the like as shown in FIGS. 4A, 4B and 4C. When the shape formed by lines connecting the centers of lens apertures is an equilateral triangle, the arrangement of microlenses is a hexagonal close-packed arrangement as shown in FIG. 2. In case of square arrangement, the shape formed by lines connecting the centers of lens apertures is a quadrangle as shown in FIGS. 5A, 5B and 5C. The quadrangle may be any of square, rectangle, and lozenge.

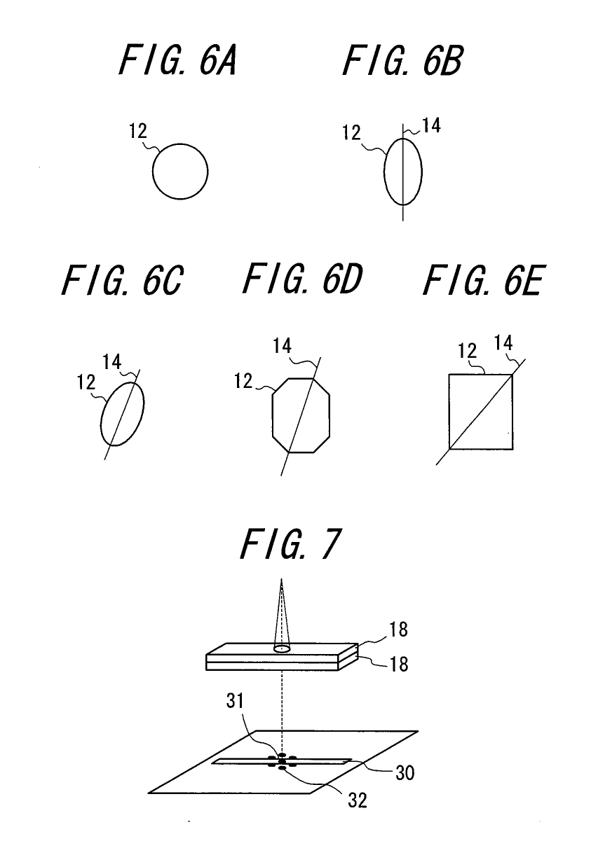

The shape of lens aperture may be any of circularity, oblong, quadrangle, and polygon as shown in FIGS. 6A-6E. In the figures, reference numeral 12 designates a lens aperture. In case of a lens the aperture thereof is other than circularity, “lens diameter D” is defined as the length of the longest line when the line 14 is drawn so as to connect both ends of the aperture (the length of the portion of the line 14 within the aperture 12 in FIGS. 6A-6E). When all of lens diameters are identical, “lens diameter D” may be defined as a lens diameter required for a view angle to be θ. Hereinafter, it is assumed that the lens diameter D is equal to the diameter of a microlens of the lens array so long as it is not clearly specified.

In the lens array composed of two lens array plates, when the lenses adjacent to each other between the two lens array plates are referred to as “inner lenses”, and the lenses not adjacent to each other between the two lens array plates are referred to as “outer lenses” (the lenses on the side of object plane and on the side of image reading plane or image writing plane), the lens diameter of an inner lens and that of an outer lens may be made equal or different.

(Explanation for the Generation of Stray Light and the Removal Thereof)

The generation of stray light will now be described. The erected imaging lens array has a imaging function as shown in FIG. 7, and is composed of at least two stacked lens array plates 18. As shown in FIG. 7, in case that the light emitted from one point 31 of the object plane 30 is imaged, if the light emitted from the point 32 other than the point 31 is incident on lenses, the light becomes stray light. The points other than the point 31 on the object plane 30 are, hereinafter, referred to as “stray light generating points”.

In order to block the incidence of the light from the stray light generating point 32, the slit and/or light-shielding wall are provided in suitable conditions. As a result, the stray light may be prevented. That is, the imaging optical system in accordance with the present invention includes the constitution for suppressing ghost by the combination of the slit and the light-shielding wall, and the constitution for suppressing ghost by the light-shielding wall only. The light-shielding wall includes two types of walls; one is an outside-formed type and the other an inside-formed type. In the outside-formed type, the light-shielding wall may be provided on both sides of the lens array or on one side thereof (on an object plane side, i.e., an object plane side to be read, or on an image reading plane side or an image writing plane side, i.e. a sensor side or a photosensitive drum side).

In an imaging optical system having a slit, the requirements for removing ghost are an inclined angle of lens arrangement direction, a slit width, a lens pitch, a view angle, and a light-shielding wall height. A slit location, a lens thickness, and a lens array width do not affect the removal of ghost, but affect the brightness of image.

(Explanation for the Inclined Angle of Lens Arrangement Direction)

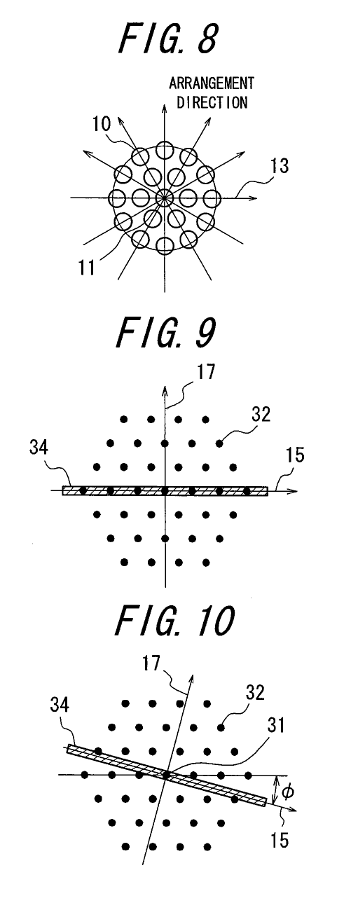

In case that the lens array plate is a hexagonal close-packed arrangement structure as shown in FIG. 2, when one lens 11 is assumed as a reference lens and lines are drawn from the reference lens to the lens adjacent thereto, 12 lines may be drawn as shown in FIG. 8. Lenses 10 are arranged along these lines, the arrangement direction thereof being referred to as a lens arrangement direction.

The lens array plate in which the lens arrangement direction 13 is coincident with the main-scanning direction will now be considered. FIG. 9 shows the distribution of stray light generating points 32 on the object plane opposing to the lens array plate. The stray light generating points are present in a hexagonal close-packed manner according to a hexagonal close-packed arrangement structure of lenses. In the figure, two lines 15 and 17 show a main-scanning direction and a sub-scanning direction perpendicular to the main-scanning direction, respectively.

As the opening 34 of a slit extends toward a main-scanning direction, the stray light from the stray light generating points 32 on the line 15 in a main-scanning direction passes through the opening 34 to generate ghost in a main-scanning direction.

In order to prevent the generation of ghost, the lens arrangement direction in the lens array plate is inclined by φ with a main-scanning direction as shown in FIG. 10 to shift the position of ghost generated in a main-scanning direction so that the ghost is generated only in a sub-scanning direction. As the ghost in a sub-scanning direction may be removed by means of a slit, the ghost is not generated in the imaging optical system as a whole.

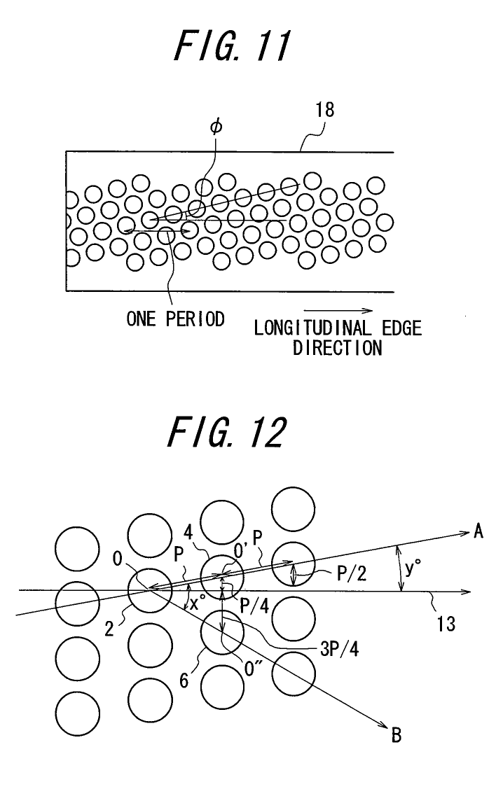

Referring to FIG. 11, there is shown the lens array plate 18 of a hexagonal close-packed arrangement in which the lens arrangement direction is inclined by φ with a main-scanning direction (which is coincident with the longitudinal edge direction of the lens array plate 18). In the lens arrangement, four lenses constitute one period in a main-scanning direction.

The most preferable inclined angle φ of the lens arrangement direction will now be considered. In order to simplify the drawing, the lens array plate of square arrangement shown in FIG. 12 is adopted as an example.

Two lens arrangement directions A, B, which are neighbored with sandwiching the main-scanning direction 13 will now be considered. The direction A is a direction such that the center point O of the reference lens 2 and the center point O′ of the first adjacent lens 4 which is most adjacent to the reference lens in the main-scanning direction are connected. The direction B is a direction such that the center point O of the reference lens 2 and the center point O″ of the second adjacent lens 6 which is most adjacent to the first adjacent lens 4 in the sub-scanning direction are connected.

It is assumed that the angle between the lens arrangement directions A and the main-scanning direction 13 is y°, and the angle between lens arrangement directions A and B is x°. In order to cause the angle y° to be the most preferable inclined angle φ of the lens arrangement direction, it is required that the stray light generating points are not present along the opening of a slit extending in the main-scanning direction. Such angle y° (i.e., the angle φ) may be geometrically calculated from FIG. 12 by the formula; y°=−0.006630x²+0.809473x−9.700729.

In the figure, P shows a lens pitch in the directions A. That is, the lens pitch P is the pitch of the lenses arranged in the direction at an angle φ inclined with the main-scanning direction. In the hexagonal close-packed arrangement shown in FIG. 11, the most preferable inclined angle φ of the lens arrangement direction is 15° from the above-described formula. The inclined angle φ is an angle with the main-scanning direction which is parallel with the longitudinal edge of the lens forming area in the lens array plate.

As described above, when the lens arrangement is selected in which the lens arrangement directions thereof is inclined at the most preferable angle with the main-scanning direction, the stray light generating points 32 may not be present on a line in the main-scanning direction, and may be present most far from in the sub-scanning direction.

The directions A and B may also be determined in the following way. The directions A is a direction such that the center point O of the reference lens (which is optionally selected) and the center point O′ of the lens which is adjacent to the reference lens (the lens may be adjacent lens other than the most adjacent lens, which is hereinafter referred to as the first adjacent lens) are connected. The direction B is a direction such that the center point O of the reference lens and the center point O″ of the lens which is adjacent to both of the first adjacent lens and the reference lens.

(Explanation for a Lens Array)

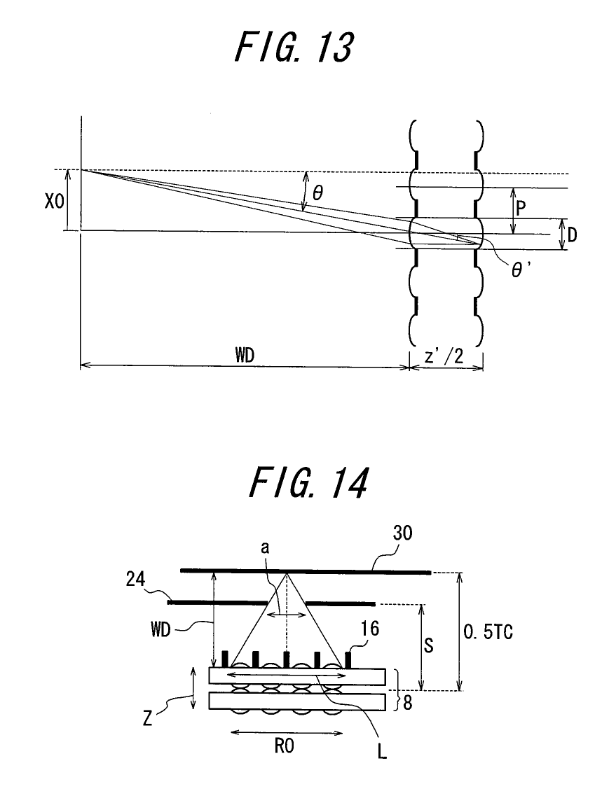

FIG. 13 is a schematic view for illustrating a view angle θ. When the light ray passing through the center of a lens among the light rays emitting from one point on the image to be read is defined as a main light ray, the view angle θ is an angle of the main light ray with respect to the optical axis of the lens.

It is preferable that a spherical lens is used in case of 0°<θ≦13°, an apherical lens in case of 13°<θ≦18°, and a Fresnel lens in case of 18°<θ≦21°. Aberration becomes large when a view angle is large, so that it is preferable that a view angle is selected to be 18° or less, more preferably be 13° or less.

If P/D becomes smaller, wherein P is a lens pitch and D a lens diameter, ghost is easily generated. If the lens diameter becomes larger, the extra light ray is easily incident, and if the lens pitch becomes smaller, the extra light ray is easily incident.

If P/D is large, the number of lenses used for imaging is small, resulting in the darkness of an image. If the lens pitch P is large, ghost is less generated. Therefore, the width a of the opening of a slit required for removing ghost may be large, and the height of a light-shielding wall to be required may be small.

In case of an imaging optical system comprising a slit, it is required that a lens arrangement direction should be inclined as described above. Brightness of an image does not depend on the inclined angle of a lens arrangement direction.

As shown in FIG. 14, the distance between outer lenses of the lens array 8 is defined as a lens thickness z. The lens thickness z does not affect the removal of stray light, but affect only the brightness of an image. While the lens thickness z does not affect the amount of stray light, the transfer ratio of an imaging light is reduced when the lens thickness z becomes larger. When z/TC (TC is a conjugation length of a lens) is small, it is difficult to fabricate a lens by which an imaging is made possible. On the other hand, when z/TC is large, the working distance WD becomes smaller. In this case, the mounting of a slit is difficult, resulting in the difficulty of assembling.

Herein, the transfer ratio of an imaging light is defined as the ratio of the amount of a transferred imaging light in a lens having a view angle in various conditions to the amount of a transferred imaging light at the light-shielding wall height 0. If the transfer ratio of an imaging light is smaller than 50%, the brightness is not enough so that an image may not be transferred.

The lens diameter D may be represented by the lens thickness z according to the following formula.

D=z×θ

The formula may be derived in the following manner. D/2=(z′/2)×tan θ′ is apparent from FIG. 13. The light ray incident at an angle θ has a relation of sin θ=n sin θ′ so that θ′=θ/n if sin θ is approximated to θ. Herein, n is a refraction index of a lens, θ′ is the angle of the light ray after passing through a lens. Also, the relationship between an actual lens thickness z and a thickness z′ (converted to a thickness of air) is z′=z×n. When z′ and θ′ are replaced by these relations in the above formula, D=z×tan θ is obtained. Using these relational expressions, the size of a slit and a light-shielding wall may also be represented by the lens thickness z.

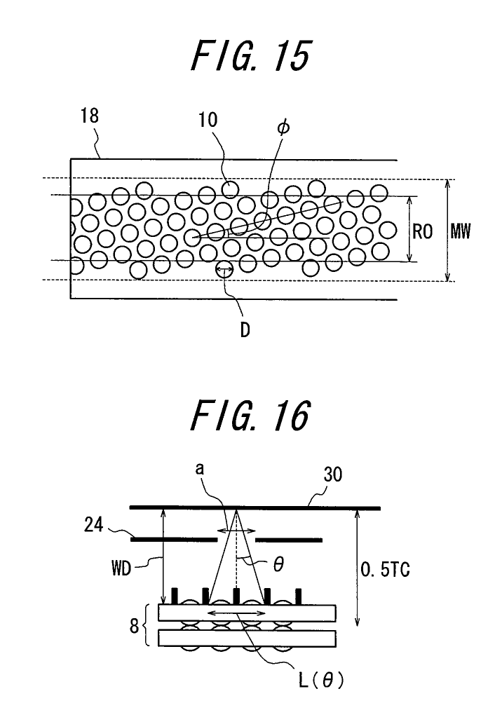

The lens row width RO does not affect the removal of stray light, but affect only the brightness of an image. Also, the lens row width RO does not affect the amount of stray light. If the lens row width RO is large, the transfer ratio of an imaging light becomes larger. If a lens array becomes larger, the apparatus grows in size, resulting in the disadvantage in mounting the apparatus on various optical equipments. If the lens row width RO is small, an image becomes darker. The lens row width RO is defined as the value of the maximum width MW of the lens forming area in a short edge direction minus the lens diameter D, i.e., RO=MW−D, as shown in FIG. 15.

It is required that the lens row width RO is larger than the smaller value of the projected width of the width a of the opening of the slit 24 on the surface of the lens array plate as shown in FIG. 14 and the projected width L(θ) of the light ray of a view angle θ on the surface of the lens array plate as shown in FIG. 16. Herein, the value of the projected width of the width a of the opening of the slit 24 is represented by a/(0.5TC−S)×(TC−z) wherein S is the distance of the slit from the center position of a lens conjugation length, and the width L(θ) of the light ray of a view angle θ is represented by (TC−z)tan θ.

(Explanation for the Improvement of the Brightness of an Image Based on the Aperture Diameter of a Lens)

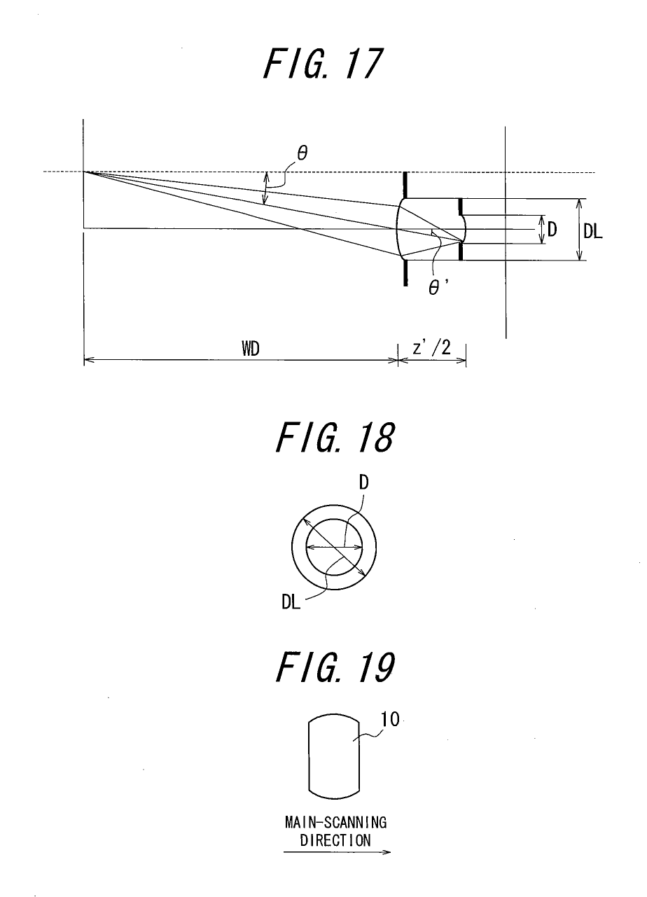

The brightness of an image may be improved by regulating the lens diameter DL of an outer lens without varying a view angle θ. When two stacked lens array plates are used, the brighter image may be obtained in the same view angle by making the lens diameter DL of an outer lens larger than the lens diameter D of an inner lens as shown in FIGS. 17 and 18. The brightness may be determined on the basis of the size of the aperture of an outer lens. Therefore, if the outer lens is a lens all the surface area thereof functions effectively, there is no “kicking” of light ray at all so that the maximum brightness may be realized in the view angle θ. In case of DL=D, the brightness is decreased when the lens pitch P is increased, while in case of DL>D, the brightness may be increased independently of the increase of the lens pitch. The brightness is not decreased in case that DL is selected to be DL>D and DL/P is made large.

In case that an image is transferred to a linear imaging region (a line sensor), only MTF (Modulation Transfer Function) in a main-scanning direction affect an image resolution, but MTF in a sub-scanning direction does not affect an image resolution. As MTF depends on a view angle θ, in a linear reading apparatus or writing apparatus, a bright image of high resolution is realized by decreasing the lens diameter of the inner lens 10 only in a main-scanning direction as shown in FIG. 19.

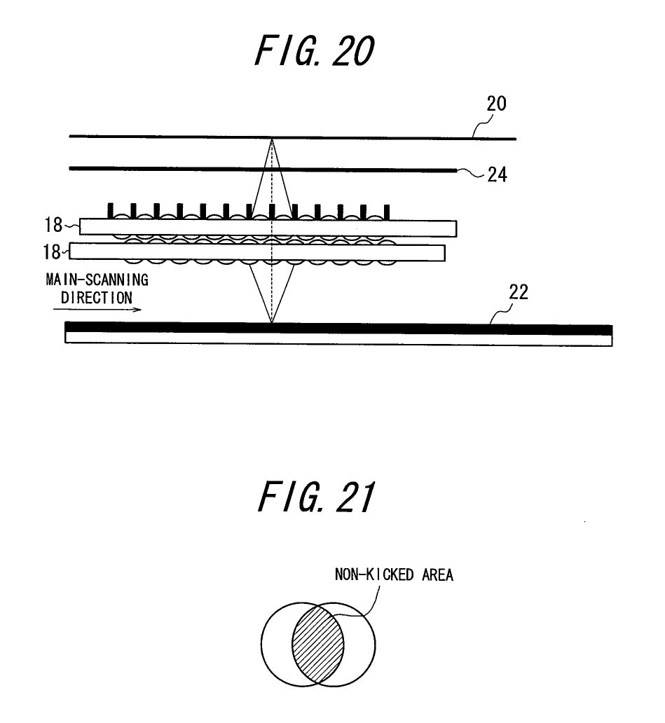

When two lens array plates 18 are shifted to each other in a main-scanning direction as shown in FIG. 20, the light ray is kicked in the area other than the overlapped area of the outer lens and the inner lens as shown in FIG. 21, so that the same effect is obtained as in the case that the lens diameter of the inner lens is made small. In FIG. 20, reference numeral 20 shows the image to be read, and 22 the line sensor.

When the bright was calculated based on the following conditions, the brightness in the case that the diameter of the inner lens was made to be 0.28 mm equivalent by shifting the lens of 0.32 mm diameter by 0.04 mm was 1.25 times the brightness in case that the lens was not shifted. The amount of stray light in the former case was 0%.

| View angle | 6.12° | |
|---|---|---|
| Actual conjunction length TC′ | 15 | mm |
| Actual lens thickness z′ | 4 | mm |
| Lens curvature R | 0.5655 | mm |
| Lens pitch P | 0.39 | mm |
| P/D | 1.25 | |
| Inclined angle of lens arrangement direction | 15° | |
| Refraction index n of lens | 1.53 | |
| Lens row width RO | 0.823 | mm |
| Main-scanning length | 100 | mm |
| Slit opening width | 0.5 | mm |
| Distance between object plane and slit | 3.343 | mm |
| Outside-formed type of light-shielding wall | | |
| (only on the object plane side) | | |
| Light-shielding wall height | 0.309 | mm |

(Explanation for Lens Array Arrangement)

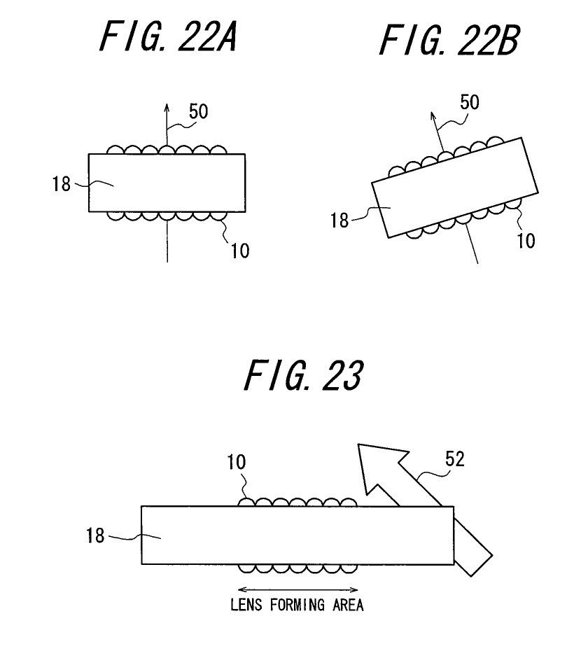

Referring to FIG. 22A, there is shown a schematic view illustrating that the lens array plate 18 is mounted in a high accuracy on the housing of an image reading apparatus or an image writing apparatus. Referring to FIG. 22B, there is shown a schematic view illustrating the lens array plate 18 mounted in an inclined manner. In this case, as the optical axis 50 is inclined, a high optical performance may not be realized, resulting the decrease of an image quality. If the area of the lens array plate is small, the lens array plate is easily being inclined when it is mounted, so that a high mounting performance is required. Therefore, it is preferable that the area of the lens array plate is large.

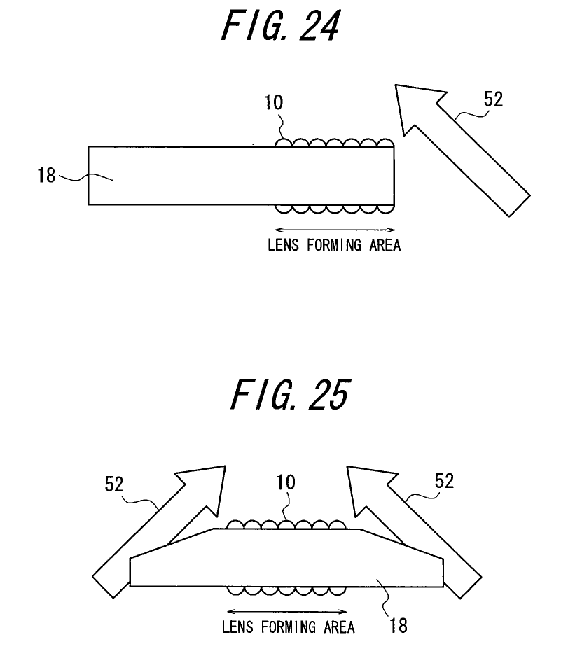

However, when the area of the lens array plate 18 is made large, the disadvantage occurs such that the irradiating light 52 from a light source is kicked by the end portion of the lens array plate 18 as shown in FIG. 23. In order to avoid this disadvantage, the lens forming area is provided on the lens array plate at the location near to the light source as shown in FIG. 24 so that the area other than the lens forming area becomes zero at the location near to the light source. That is, if the lens forming area is provided close to the end portion of the lens array plate, the kicking of the irradiating light may be prevented.

The structure shown in FIG. 24 may not be applied only to one-side irradiation. In case of both-side irradiation, the kicking of the irradiating light may be reduced by cutting off both edges of the lens array plate as shown in FIG. 25. In case of one-side irradiation, only the edge near to the light source may be cut off.

(Explanation for a Light-Shielding Wall)

On at least one lens array plate, provided is a light-absorbing wall (a light-shielding wall) between lenses to prevent unnecessary light ray. A light-shielding wall is provided on the surface of the lens array plates, or provided in the lens array plates.

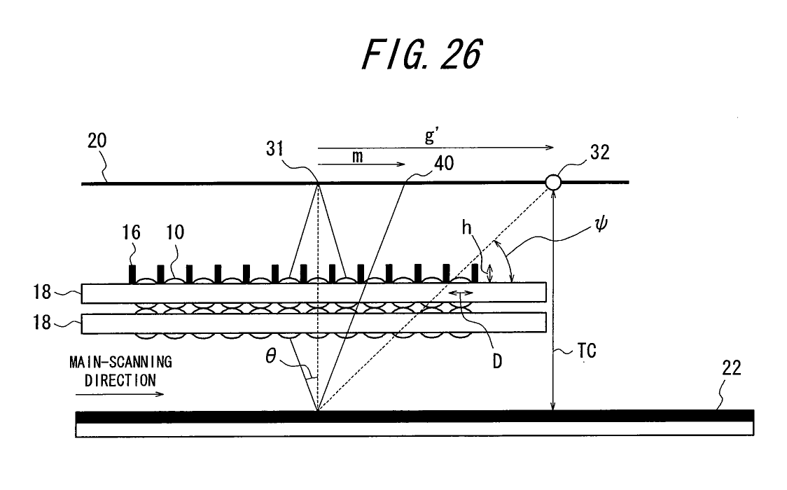

Referring to FIG. 26, there is shown an example in which the light-shielding wall 16 is formed on the lens array plate 18 (outside-formed type) in an imaging optical system of an image reading apparatus. In the figure, reference numeral 20 shows an image to be read (an original) and 22 a line sensor.

In case of such an outside-formed type of light-shielding wall, the light-shielding wall is formed by painting in piles a black ink of high viscosity on the lens 10, or by mounting a black rein molded component or the like on the lens array plate 18, the black rein molded component being formed so as to cover the area other than lenses.

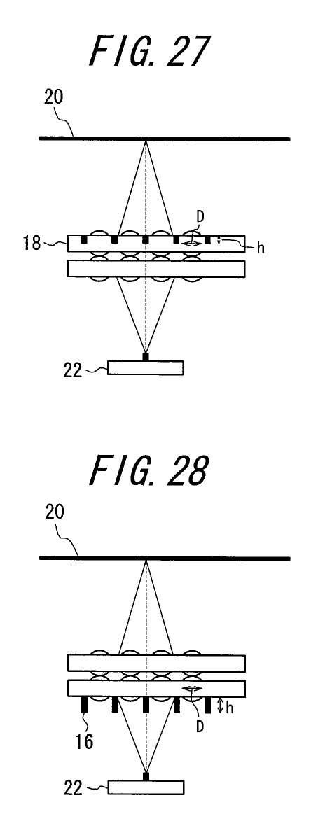

Referring to FIG. 27, there is shown an example in which the light-shielding wall 16 is formed in the lens array plate 18 (inside-formed type) in an imaging optical system of an image reading apparatus. In case of such an inside-formed type of light-shielding wall, the light-shielding wall is formed by making the lens array plate of resin which may be colored by laser irradiation and irradiating a laser to an area where the light-shielding wall is to be formed, or by providing trenches around respective lenses and filling a black ink or the like in the trenches.

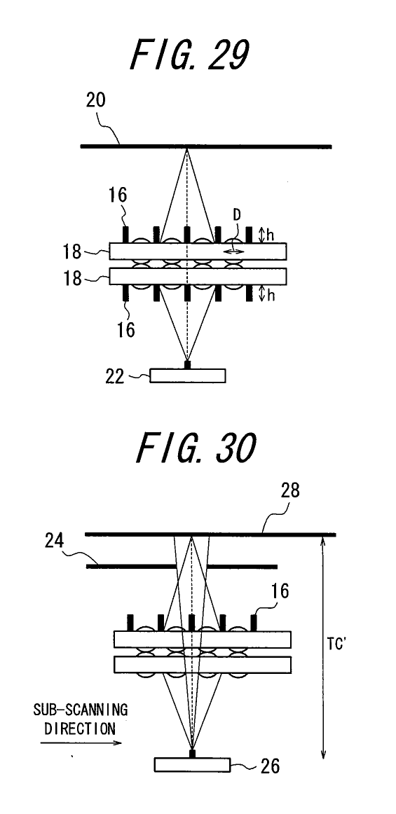

The outside-formed type of light-shielding wall may be provided only on the topmost surface of the lens array plate on the side of the object plane to be read as shown in FIG. 26, or may be provided only on the bottommost surface of the lens array plate (the topmost surface on the side of the imaging plane) as shown in FIG. 28. Alternatively, the light-shielding wall may be provided on both of the topmost and bottommost surfaces as shown in FIG. 29, or may be provided between the lens array plates (i.e., inside the lens array plates).

In FIG. 10, the stray light from the stray light generating points 32 nearest to the image point 31 to be read, and the stray light present at the far location in the sub-scanning direction 17 may be removed by means of the slit. However, the stray lights may not be completely removed by means of the slit only, because the size of the stray light generating point 32 far from the image point 31 to be read becomes larger due to defocusing. The stray lights which may not be removed by means of the slit are removed by means of the light-shielding wall. The method for determining the height of the light-shielding wall will now be described.

As described above, there are two types of outside-formed light-shielding wall and inside-formed light-shielding wall. First, the outside-formed type of light-shielding wall will be described.

As the stray lights present near to the slit are removed by the slit, the stray lights present far from the slit and then impossible to be removed will now be considered. As shown in FIG. 26, when the stray light is generated at the location g′ having a proportional relation (proportional constant is e′) with respect to the location 40 (the location at the distance m from the optical axis) where the light ray extended by a view angle θ arrives at the object plane 20 to be read, the following relations are established; m=tan θ×TC and g′=m×e'=(tan θ×TC)×e′. If the inclination Ψ(tan Ψ=h/D) at which the height h of the light-shielding wall 16 is with the lens 10 is larger than the inclination of the light ray coming from the location g′ to the sensor 22, the stray lights may be removed. Herein, D is a lens diameter (the diameter of the portion which functions effectively as a lens).

TC/(tan θ×TC×e′)≦(h/D)

The above expression may be varied to 1/e′≦(h/D)×tan θ. Herein, if 1/e′=e, then e≦h/D×tan θ.

When the lens diameter DL of an outer lens is larger than the lens diameter D of an inner lens, e≦h/DL×tan θ is established using the intermediate value DM=(DL+D).

In case that the light-shielding wall is of an outside-formed type, the height of the light-shielding wall becomes higher, the brightness is reduced, while in case that the light-shielding wall is of an inside-formed type, the height h of the light-shielding wall is irrelevant to the brightness. When the lens pitch P is large, the light-shielding wall height h becomes lower. Also, if the lens pitch P is small, the stray light is easily be generated, so that the proportional constant e may be represented by the following formula.

e=(h/DM)×tan θ×(P/1.25D)

From the simulation result described hereinafter, it is appreciated that when the light-shielding wall is provided on both surfaces of the lens array plates, the light-shielding wall height h may be selected to be low compared with the case such that the light-shielding wall is provided on one surface of the lens array plates.

Also, in case that the light-shielding wall is provided on both surfaces of the lens array plates, the brightness tends to be low compared with the case such that the light-shielding wall is provided on one surface of the lens array plates.

While the thickness of the inside-formed light-shielding wall is represented by an air-converted thickness, the actual thickness of the inside-formed light-shielding wall is 1.53 times the air-converted thickness. In case of the outside-formed light-shielding wall, the air-converted thickness is equal to the actual thickness.

When the light-shielding wall height h is high, the stray light may easily be removed, but the brightness becomes lower. In this manner, the removal of the stray light and the amount of light are related in trade-off. For example, if the proportional constant e is large, the stray light becomes zero % irrelevant of a view angle. However, in order to obtain the amount of light (the transfer ratio of imaging light) of 50% or more, it is required that the proportional constant e is equal to or smaller than a constant value.

In case of the inside-formed light-shielding wall, it is possible to prevent the incidence of stray light to the adjacent lenses as shown in FIG. 27. Also, there is no “kicking” of the stray light for imaging, and then it is a merit that the transmissibility (the amount of light) does not become smaller if the height of the light-shielding wall 16 is high.

The height (depth) of the inside-formed light-shielding wall may be basically determined on the basis of the same idea as in the outside-formed light-shielding wall. For example, when the maximum height of the outside-formed light-shielding wall is 0.25 mm, the height of the inside-formed light-shielding wall having the same effect is 0.25×1.53=0.3825 mm which is a value returned from the air-converted thickness.

The stray light may be prevented only by a light-shielding wall without providing a slit. The light-shielding walls are provided around respective lenses, so that the stray light may be removed in both main-scanning and sub-scanning directions. As a slit in not provided, the inclination of the lens arrangement direction is not required. In order to prevent the stray light only by means of a light-shielding wall, the stray light may not be removed if not the height of the light-shielding wall is selected to be high compared with the case in which a slit is provided.

In case of the structure having no slit, the necessary requirements are the light-shielding wall height h and the lens pitch P. The lens thickness z and the lens row width RO do not affect the removable of stray light, but affect the brightness.

The optical absorptance and the surface roughness of a light-shielding wall are requirements that affect the removal of ghost. Even if the optical absorptance of a light-shielding wall is low, the amount of stray light may be reduced by increasing the surface roughness of a light-shielding wall.

If the optical absorptance of a light-shielding wall is low (or the optical reflectance is high), the light ray is reflected on the light-shielding wall to generate further stray light. Therefore, it is preferable that the light-shielding wall is made of the material of high optical absorptance such as black ink. As the light is less reflected when the surface roughness is large, the optical absorptance may be increased by making the surface roughness large in case of low absorptance material. For example, the surface roughness of frosted glass is on the order of a few μm.

(Explanation for a Simulation Calculation Method)

A simulation calculation method used in the present invention will now be described. In the following explanation, it is to be noted that the lens thickness z and the conjugation length TC are not actual values but air-converted values described hereinafter.

The imaging optical system in an image reading apparatus will now be described as an example, the system being provided with the slit 24 and the light-shielding wall 16 shown in FIG. 14. A virtual light source 26 was provided on the side of a sensor and an evaluation plane 28 was provided on the side of the object plane to be read as shown in FIG. 30. The size of the evaluation plane 28 was 200 mm×200 mm. The actual conjugation length TC′ was 15 mm.

The light ray of extended angle 90° at Lambertian model was generated by means of the virtual light source 26 on the sensor side in the image reading apparatus. The amount of energy arrived at the evaluation plane 28 was measured to evaluate the ghost and the amount of light.

The ratio of 100% of the incident energy to the energy (the amount of transferred imaging light) arrived at the intersecting point between the light axis and the evaluation plane 28 is referred to as a transfer ratio of imaging light. The amount of transferred imaging light is the amount of light in the imaging optical system. The total amount of energy arrived at the point other than the intersecting point on the evaluation plane 28 is the amount of stray light. If the amount of stray light becomes larger, the ghost is remarkably generated.

Also, in case of the image writing apparatus, the virtual light source was provided on the side of a light source, and the light ray of extended angle 90° at Lambertian model was generated by means of the virtual light source. The amount of energy arrived at the evaluation plane 28 was measured to evaluate the ghost and the amount of light.

In the tracing of the light ray in the calculation model, while the direction of the light ray is opposite to that in an actual image reading apparatus and an actual writing apparatus, the same result as in an actual image reading apparatus and an actual image writing apparatus according to the optical retrodirective principle. That is, as a result of a calculation, if the amount of stray light is 0%, the energy value of the light ray from the object plane is substantially equal to the energy value of the light ray arrival at the intersecting point between the light axis and the imaged picture on the imaging plane. The calculation was carried out on condition that the number of light rays was 10,000. The size of the evaluation plane was selected to be large such as 200 mm×200 mm as described above. If the amount of stray light is 0%, the ghost is on a level such that the ghost is not detected by means of a sensor. If the amount of stray light is 10% or less, the ghost is on a level such that while the ghost is detected by means of a sensor, the affect of the ghost may be removed completely by a succeeding signal processing.

The energy variation (the unevenness of the amount of light) in a main-scanning direction was also evaluated. While the light ray was of Lambertian model, the light ray having a view angle of +5° was used without using the light ray having an extended angle of 90° in order to carry out a calculation effectively. The calculation result is shown by values converted so as to correspond to an extended angle of 90° at Lambertian model. The number of light rays was selected to be 10,000. The unevenness of the amount of light was determined by the following formula.

The unevenness of the amount of light=(Maximum amount of transferred imaging light−Minimum amount of transferred imaging light)/(Maximum amount of transferred imaging light+Minimum amount of transferred imaging light)

(Simulation Result for a Light-Shielding Wall)

The simulation result for an optical reflectance of the light-shielding wall and the stray light in the light- shielding wall is shown in Table 1.

TABLE 1

| | REFLECTANCE | | |
|---|---|---|---|
| VIEW ANGLE | 5% | 10% | 50% |
| 7.56 | 0% | 2% | 10% |
| 3.71 | 0% | 2% | 10% |
| 11.08 | 0% | 2% | 10% |
| 15.92 | 0% | 2% | 10% |
| 25.30 | 0% | 2% | 10% |

Because of optical absorptance=(100−Optical reflectance), it is appreciated from Table 1 that the optical absorptance of the light-shielding wall is preferably 50-100% (the amount of stray light is 10% or less), more preferably 95-100% (the amount of stray light is 0%).

The simulation result for the surface roughness Ra and the stray light in the light-shielding wall of the optical absorptance 90%(the optical reflectance 10%) is shown in Table 2.

TABLE 2

SURFACE ROUGHNESS

| VIEW ANGLE | ≈0 nm | 5 nm | 10 nm | 20 nm |
|---|---|---|---|---|
| 7.56 | 2% | 1% | 0% | 0% |
| 3.71 | 2% | 1% | 0% | 0% |
| 11.08 | 2% | 1% | 0% | 0% |
| 15.92 | 2% | 1% | 0% | 0% |
| 25.30 | 2% | 1% | 0% | 0% |

It is appreciated from Table 2 that when the optical absorptance of the light-shielding wall is 90% or more (the optical reflectance 10% or less), the amount of stray light may be 0%, if the surface roughness Ra is 10 nm or more.

The simulation result for the surface roughness Ra and the stray light in the light-shielding wall of the optical absorptance 50% (the optical reflectance 50%) is shown in Table 3.

TABLE 3

SURFACE ROUGHNESS

| VIEW ANGLE | 20 nm | 30 nm | 40 nm | 50 nm |
|---|---|---|---|---|
| 7.56 | 3% | 2% | 1% | 0% |
| 3.71 | 3% | 2% | 1% | 0% |
| 11.08 | 3% | 2% | 1% | 0% |
| 15.92 | 3% | 2% | 1% | 0% |
| 25.30 | 3% | 2% | 1% | 0% |

It is appreciated from Table 3 that when the optical absorptance of the light-shielding wall is 50% or more (the optical reflectance 50% or less), the amount of stray light may be 0%, if the surface roughness Ra is 50 nm or more.

The simulation result for the surface roughness Ra and the stray light in the light-shielding wall of the optical absorptance 0% (the optical reflectance 100%) is shown in Table 4.

TABLE 4

SURFACE ROUGHNESS

| VIEW ANGLE | 200 nm | 300 nm | 400 nm | 500 nm |
|---|---|---|---|---|
| 7.56 | 3% | 2% | 1% | 0% |
| 3.71 | 3% | 2% | 1% | 0% |
| 11.08 | 3% | 2% | 1% | 0% |
| 15.92 | 3% | 2% | 1% | 0% |
| 25.30 | 3% | 2% | 1% | 0% |

It is appreciated from Table 4 that when the optical absorptance of the light-shielding wall is 0% or more (the optical reflectance 100% or less), the amount of stray light may be 0%, if the surface roughness Ra is 500 nm or more.

(Simulation Result for a Slit)

A slit may be provided between the lens array and the object plane to remove the unnecessary light ray. FIG. 14 shows an example in which the slit 24 is provided in the imaging optical system shown in FIG. 26.

When the slit is provided, in order to make the stray light removal by the slit more effective, it is preferable that lenses are arrayed so that the arrangement direction of lenses 10 is not coincident with the longitudinal edge direction of the lens forming area as shown in FIG. 15. FIG. 15 shows the case such that the arrangement direction of lenses is inclined at φ with the longitudinal edge direction of the lens forming area.

There are two parameters c and d regarding to the width of the opening of the slit. The parameter c designates the presence or absence of the removal of stray light, and the parameter d the presence or absence of “kicking”.

When the width of the opening of the slit is represented by a, and the distance of the slit from the center position of the lens conjugation length is represented by C, the parameter c may be defined by the following formula.

c={a/(2S)×tan 2θ×sin 15°)}×(1.25D/P)

When the lens pitch becomes larger, it is required that the width of the opening of the slit is made large.

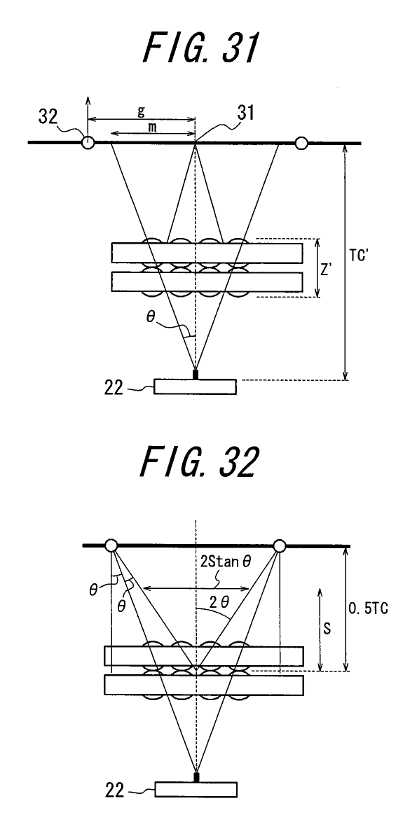

A view angle of a lens is also related to the definition of the width of the opening of the slit. The width of the opening of the slit (the width in a sub-scanning direction) may be broad when the distance between the image point to be read and the stray light generating point is large, and may be narrow when the distance is small. As shown in FIG. 31, the distance between the image point 31 to be read and the stray light generating point 32 is represented by g, and the distance between the point projected on the object plane to be read at a view angle θ from the sensor side and the image point 31 to be read is represented by m. As the distance g is proportional to the distance m, g/m=e is established. As the removal of ghost depends on the value of c regardless of the view angle θ, it is appreciated that the distance g is proportional to the distance m.

In case that the distance m is defined as shown in FIG. 31, m=TC′ tan θ is not established, wherein TC′ is the lens conjugation length, because the position to be projected is shifted due to the refraction occurred in the lens array. Therefore, when the actual lens thickness (the length between the highest portion of lenses on the topmost surface of the lens array and the highest portion of lenses on the bottommost surface of the lens array) is represented by z′, and the refraction of the lens is represented by n, the lens thickness z is treated as an air-converted thickness z=z′/n. Also, the lens conjugation length TC′ is treated as an air-converted conjugation length TC, resulting in TC=TC′−z+z/n. For example, when the actual lens thickness z′=4 mm, the air-converted lens thickness is obtained by dividing the actual lens thickness by the refraction index of air, resulting in 4/1.53=2.61 mm. When the lens conjugation length TC′=15 mm, the air-converted conjugation length TC is 15−4+2.61=13.61 mm. By carrying out an air-conversion, the distance m may be treated as m=tan θ×TC, resulting in g=c×tan θ×TC.

For simplifying an explanation, it will be considered hereinafter as c=1. The ghost is also collected into the lenses as show in FIG. 32, so that it is recognized that the light ray is extended at a view angle θ from the location where the first ghost is generated, and arrives at the sensor. The innermost stray light may be represented so as to have geometrically the extension of 2θ from the center position of the lens conjugation length TC. Therefore, the width in which there is no stray light at the distance S from the center position of the lens conjugation length TC is 2S tan 2θ.

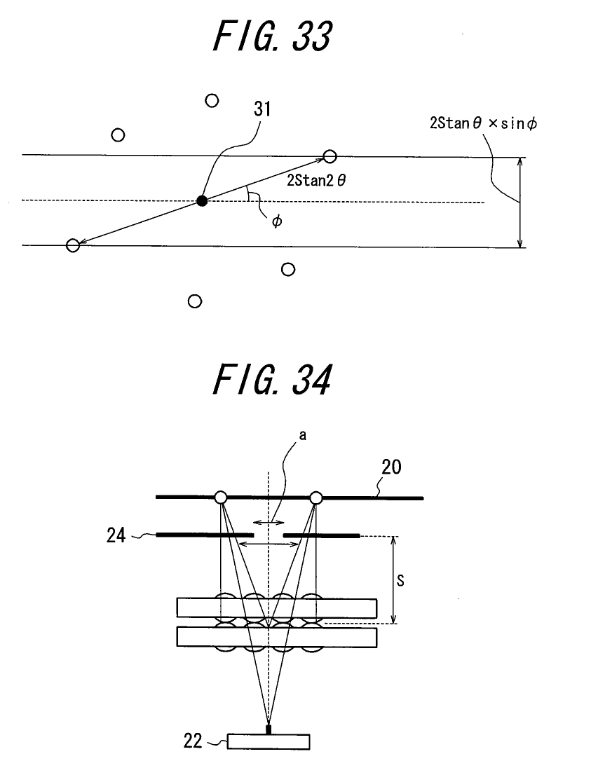

The lens arrangement direction is inclined at an angle φ as shown in FIG. 33, so that the width in which there is no stray light is 2S tan 2θ×sin φ by multiplying 2S tan 2θ by sin φ. As shown in FIG. 34, the width a required for the opening of the slit at the location S from the center position of the lens conjugation length TC to the slit 24 is 2S tan 2θ×sin φ. While it has been assumed hitherto to be c=1 for simplifying the explanation, c is in fact c=a/(2S tan 2θ×sin φ). As a=2S tan 2θ×sin φ×c shows the width wherein there is no stray light, the width of the opening of the slit is required to be smaller than 2S tan 2θ×sin φ×c. When sin φ was varied in the simulation, it has been appreciated that the optimum condition by which the amount of stray light is least may be obtained when the width of the opening of the slit is calculated at φ=15°. Therefore, it was assumed to be φ=15°.

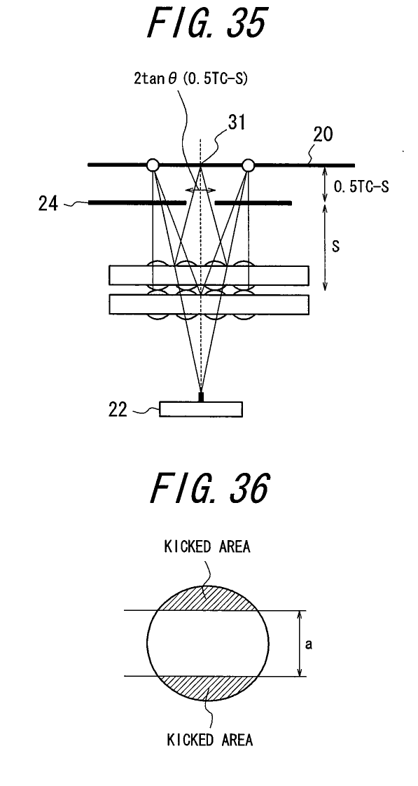

The smallest value of the opening width of the slit may be determined as follows. FIG. 35 shows a schematic view in which the light ray extended at a view angle from the image point 31 is added to FIG. 34. As shown in FIG. 35, the imaging light has an extension of view angle θ from the object plane (an original) 20 to be read. If the slit 24 is engaged with the extension of view angle θ, the phenomena such that the light ray required for imaging is interrupted, so-called “kicking” occurs to prevent the imaging of a part of image. As “kicking” occurs from the peripheral portion of the image as shown in FIG. 36, the effect thereof for the imaging is less even if some kicking occurs.

The distance from the center position of the lens conjugation length TC to the slit 24 is S, then the distance from the original 20 to the slit is 0.5TC−S and the range wherein “kicking” does not occur is 2 tan θ×(0.5TC−S). If the ratio of the width of the slit opening to the range, i.e., d=a/(2 tan θ×(0.5TC−S)) is 1 or more, “kicking” does not occur. If the ratio d is near to 1, the amount of light becomes larger, and if the ratio d is small, the unevenness of the amount of light becomes smaller. When the distance between the slit and the lens array is small, the width of the slit opening is required to be small. However, if the width of the slit opening is small, “kicking” occurs and the image becomes dark.

While the amount of stray light is not varied on the basis of on the location of the slit, if S/TC becomes smaller, the slit and the lens array are easily be contacted, which is not desirable. If S/TC is larger than a constant value, the transfer ratio of imaging light is 50% or more, and if S/TC becomes too large, the slit and the object plane to be read are easily contacted, which is not desirable. In case of an image reading apparatus, a glass plate is provided between the object plane to be read and the slit, so that the slit and the lens array are contacted.

The slit may be provided not only between the lens array and the object plane, but also between the lens array and the image reading plane (the sensor). While the light reflected on the parts in the image reading apparatus is contributed to the stray light, the amount of such stray light is less, so that the effect for the image quality is small. However, a slit may be provided on the side of the image reading plane, so that the stray light may be effectively prevented. Therefore, in order to realize the higher quality image, it is preferable that slits are provided on both sides of the object plane and the image reading plane. The values of the opening width of the slit provided on the side of the image reading plane may be identical to that of the slit provided on the side of the object plane.

Hereinafter, the embodiments will now be described on the basis of the presence or absence of a slit, the types of light-shielding wall (the outside-formed type or the inside-formed type), and the arrangement locations of light-shielding wall (on the side of the object plane or on the side of the image reading/writing plane).

1. Presence of a Slit, Outside-Formed Type Light-Shielding Wall Provided only on the Side of the Object Plane:

The simulation result for the variation of the amount of stray light/the amount of transferred imaging light is shown in Table 5.

TABLE 5

| | INCLINED ANGLE | | | | | | | | | | | |
|---|---|---|---|---|---|---|---|---|---|---|---|---|
| VIEW ANGLE | 0° | 8° | 9° | 10° | 11° | 12° | 13° | 14° | 15° | 16° | 17° | 18° |
| 6.12 | 234% | 38% | 13% | 1% | 1% | 0% | 0% | 0% | 0% | 0% | 2% | 7% |
| 0.5 | | | | 20% | 0% | 0% | 0% | 0% | 0% | 0% | 33% | |
| 3 | | | | 10% | 0% | 0% | 0% | 0% | 0% | 0% | 15% | |
| 9 | | 22% | 5% | 2% | 2% | 0% | 0% | 0% | 0% | 0% | 0% | 0% |
| 13 | | 18% | 9% | 2% | 2% | 0% | 0% | 0% | 0% | 0% | 0% | 0% |
| 18 | | 15% | 7% | 2% | 2% | 0% | 0% | 0% | 0% | 0% | 0% | 0% |
| 21 | | 11% | 4% | 2% | 2% | 0% | 0% | 0% | 0% | 0% | 0% | 0% |
| | INCLINED ANGLE | | | | | | | | | | | |
| | 19° | 20° | 21 | 22 | 23 | 24 | 25° | 26 | 27 | 28 | 29 | 30° |
| 6.12 | 10% | 7% | 11% | 11% | 11% | 11% | 11% | | | | | 88% |
| 0.5 | | | | | | | | | | | | |
| 3 | | | | | | | | | | | | |
| 9 | 0% | 0% | 0% | 0% | 0% | 0% | 2% | 9% | 20% | | | |
| 13 | 0% | 0% | 0% | 0% | 0% | 0% | 2% | 7% | 18% | | | |
| 18 | 0% | 0% | 0% | 0% | 0% | 0% | 2% | 5% | 13% | | | |
| 21 | 0% | 0% | 0% | 0% | 0% | 0% | 2% | 1% | 12% | | | |

The simulation result for the variation of the amount of stray light/the amount of transferred imaging light for c=a/(2S×tan 2θ×sin 15°) is shown in Table 6.

TABLE 6

| | C | | | | | | | | | | |
|---|---|---|---|---|---|---|---|---|---|---|---|
| VIEW ANGLE | 0.466 | 0.603 | 0.663 | 0.829 | 0.995 | 1.160 | 1.305 | 1.327 | 1.492 | 1.658 | 1.767 |
| | 0% | 0% | 0% | 0% | 0% | 0% | 0% | 0% | 2% | 9% | 11% |
| 0.5 | 0% | 0% | 0% | 0% | 0% | 0% | 0% | 0% | 51% | 101% | 310% |
| 3 | 0% | 0% | 0% | 0% | 0% | 0% | 0% | 0% | 20% | 40% | 110% |
| 9 | 0% | 0% | 0% | 0% | 0% | 0% | 0% | 0% | 1% | 4% | 11% |
| 13 | 0% | 0% | 0% | 0% | 0% | 0% | 0% | 0% | 1% | 2% | 11% |
| 18 | 0% | 0% | 0% | 0% | 0% | 0% | 0% | 0% | 1% | 2% | 11% |
| 21 | 0% | 0% | 0% | 0% | 0% | 0% | 0% | 0% | 1% | 1% | 11% |

The simulation result for the variation of the amount of stray light/the amount of transferred imaging light for P/D is shown in Table 7.

TABLE 7

| VIEW | P/D | | | | | | | | |
|---|---|---|---|---|---|---|---|---|---|
| ANGLE | 1.034 | 1.142 | 1.180 | 1.216 | 1.250 | 1.450 | 1.570 | 1.678 | 2.157 |
| 6.12 | 9% | 0% | 0% | 0% | 0% | 0% | 0% | 0% | 0% |
| 0.5 | 101% | 0% | 0% | 0% | 0% | 0% | 0% | 0% | 0% |
| 3 | 55% | 0% | 0% | 0% | 0% | 0% | 0% | 0% | 0% |
| 9 | 5% | 2% | 0% | 0% | 0% | 0% | 0% | 0% | 0% |
| 13 | 4% | 2% | 0% | 0% | 0% | 0% | 0% | 0% | 0% |
| 18 | 2% | 1% | 0% | 0% | 0% | 0% | 0% | 0% | 0% |
| 21 | 0% | 0% | 0% | 0% | 0% | 0% | 0% | 0% | 0% |

The simulation result for the variation of the amount of stray light/the amount of transferred imaging light for DL/P is shown in Table 8.

TABLE 8

| | DL/P | | | | |
|---|---|---|---|---|---|
| VIEW ANGLE | 0.700 | 0.750 | 0.850 | 0.900 | 0.950 |
| 6.12 | 0% | 0% | 0% | 0% | 0% |
| 0.5 | 0% | 0% | 0% | 0% | 0% |
| 3 | 0% | 0% | 0% | 0% | 0% |
| 9 | 0% | 0% | 0% | 0% | 0% |
| 13 | 0% | 0% | 0% | 0% | 0% |
| 18 | 0% | 0% | 0% | 0% | 0% |
| 21 | 0% | 0% | 0% | 0% | 0% |

The simulation result for the variation of the transfer ratio of imaging light for e=(h/DM)×tan θ×(P/1.25D) is shown in Table 9.

TABLE 9

| | e | | | | | | | |
|---|---|---|---|---|---|---|---|---|
| VIEW ANGLE | 0.000 | 0.019 | 0.039 | 0.057 | 0.077 | 0.087 | 0.096 | 0.103 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value such that the amount of stray light at respective view angles is 10% or less are found out from Tables 5-9, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The lens arrangement of the lens array plate is hexagonal arrangement. The light-shielding wall is provided only on the lens array plate on the side of the object plane. The view angle θ of a lens of the lens array plate is of 0°<θ≦21°. The angle φ at which the lens arrangement direction of the lens array plate is inclined with the direction of the longitudinal edge of the lens forming area of the lens array plate is of 9°<φ≦27°, in particular, 11°≦φ<17° for 0°<θ<3°, and 10°≦φ<16° for 3°≦θ<9°. Herein, the width of the slit opening is represented by a, the distance from the center position of lens conjugation length to the slit by S, the lens pitch of the lens array plate by P, and the lens diameter of the inner lens by D. The value of c={) a/(2S×tan 2θ×sin 15°}×(1.25D/P) is of 0.466≦c<1.767, in particular, 0.466≦c<1.492 for 0°<θ<6.12°. The value of P/D is 1.0344≦P/D<2.157, in particular, 1.142≦P/D<2.157 for 0°<θ<6.12°. When the lens diameter of the outer lens is represented by DL, DL/P is 0.7≦DL/P<0.950. When the height of the light-shielding wall is represented by h, and the value of DM is defined by DM=(DL+D)/2, e=(h/DM)×tan θ×(P/1.25D) is of 0<e, in particular, 0.087≦e for 0°<θ<6.12°, and 0.039≦e for 6.12°≦θ<9°.

The conditions for causing the amount of stray light at respective view angles to be 0% are as follows. The lens arrangement of the lens array plate is hexagonal arrangement. The light-shielding wall is provided only on the lens array plate on the side of the object plane. The view angle θ is of 0°<θ≦21°. The inclined angle φ is of 11°≦φ<25°, in particular, 11°≦φ<17° for 0°<θ≦6.12°, and 12≦φ<17° for 6.12°≦θ<9°. The value of c is of 0.466≦c<1.492. The value of P/D is of 1.034≦P/D<2.157, in particular, 1.142≦P/D<2.157 for 0°<θ<9°, and 1.180≦P/D<2.157 for 9°≦θ<21°. The value of DL/P is of 0.7≦DL/P<0.950. The value of e is of 0.057≦e, in particular, 0.087≦e for 0°<θ<6.12°, and 0.077≦e for 9°≦θ<21°.

The conditions for causing the amount of stray light at all of view angles to be 10% or less are as follows. The lens arrangement of the lens array plate is hexagonal arrangement. The light-shielding wall is provided only on the lens array plate on the side of the object plane. The view angle θ is of 0°<θ≦21°. The inclined angle φ is of 11°≦φ<17°. The value of c is of 0<c<1.492. The value of P/D is of 1.142≦P/D. The value of e is 0.087≦e.

The conditions for causing the amount of stray light at all of view angles to be 0% are as follows. The lens arrangement of the lens array plate is hexagonal arrangement. The light-shielding wall is provided only on the lens array plate on the side of the object plane. The view angle θ is of 0°<θ≦21°. The inclined angle φ is of 12°≦φ<17°. The value of c is of 0<c<1.492. The value of P/D is of 1.180≦P/D. The value of e is 0.087≦e.

The simulation result for the variation of the transfer ratio of imaging light for d=a/(2 tan θ×(0.5TC−S)) and the variation of unevenness of the amount of light are shown in Table 10.

TABLE 10

| | d | | | | | | | | | | |
|---|---|---|---|---|---|---|---|---|---|---|---|
| VIEW ANGLE | 0.242 | 0.255 | 0.331 | 0.364 | 0.455 | 0.546 | 0.637 | 0.717 | 0.728 | 0.820 | 0.911 |
| 6.12 | 49% | 52% | 62% | 67% | 79% | 90% | 95% | 96% | 96% | 96% | 96% |
| 0.5 | 49% | 52% | 62% | 67% | 79% | 90% | 95% | 96% | 96% | 96% | 96% |
| 3 | 49% | 52% | 62% | 67% | 79% | 90% | 95% | 96% | 96% | 96% | 96% |
| 9 | 49% | 52% | 62% | 67% | 79% | 90% | 95% | 96% | 96% | 96% | 96% |
| 13 | 49% | 52% | 62% | 67% | 79% | 90% | 95% | 96% | 96% | 96% | 96% |
| 18 | 49% | 52% | 62% | 67% | 79% | 90% | 95% | 96% | 96% | 96% | 96% |
| 21 | 49% | 52% | 62% | 67% | 79% | 90% | 95% | 96% | 96% | 96% | 96% |

The simulation result for the variation of the transfer ratio of imaging light for P/D is shown in Table 11.

TABLE 11

| VIEW | P/D | | | | | | | | |
|---|---|---|---|---|---|---|---|---|---|
| ANGLE | 1.034 | 1.142 | 1.180 | 1.216 | 1.250 | 1.450 | 1.570 | 1.678 | 2.157 |
| 6.12 | 116% | 95% | 89% | 84% | 79% | 59% | 50% | 40% | 30% |
| 0.5 | 116% | 95% | 89% | 84% | 79% | 59% | 50% | 40% | 30% |
| 3 | 116% | 95% | 89% | 84% | 79% | 59% | 50% | 40% | 30% |
| 9 | 116% | 95% | 89% | 84% | 79% | 59% | 50% | 40% | 30% |
| 13 | 116% | 95% | 89% | 84% | 79% | 59% | 50% | 40% | 30% |
| 18 | 116% | 95% | 89% | 84% | 79% | 59% | 50% | 40% | 30% |
| 21 | 116% | 95% | 89% | 84% | 79% | 59% | 50% | 40% | 30% |

The simulation result for the variation of the transfer ratio of imaging light for e=(h/DM)×tan θ×(P/1.25D) is shown in Table 12.

TABLE 12

| | e | | | | | | |
|---|---|---|---|---|---|---|---|
| VIEW ANGLE | 0.103 | 0.288 | 0.384 | 0.479 | 0.574 | 0.687 | 0.768 |
| 6.12 | 79% | 70% | 67% | 61% | 55% | 50% | 44% |
| 0.5 | 79% | 70% | 67% | 61% | 55% | 50% | 44% |
| 3 | 79% | 70% | 67% | 61% | 55% | 50% | 44% |
| 9 | 79% | 70% | 67% | 61% | 55% | 50% | 44% |
| 13 | 79% | 70% | 67% | 61% | 55% | 50% | 44% |
| 18 | 79% | 70% | 67% | 61% | 55% | 50% | 44% |
| 21 | 79% | 70% | 67% | 61% | 55% | 50% | 44% |

The simulation result for the variation of the transfer ratio of imaging light for S/TC is shown in Table 13.

TABLE 13

| | S/TC | | | | | | | |
|---|---|---|---|---|---|---|---|---|
| VIEW ANGLE | 0.5 | 0.328 | 0.291 | 0.254 | 0.218 | 0.213 | 0.191 | 0.144 |
| 6.12 | 96% | 96% | 95% | 79% | 61% | 60% | 51% | 36% |
| 0.5 | 96% | 96% | 95% | 79% | 61% | 60% | 51% | 36% |
| 3 | 96% | 96% | 95% | 79% | 61% | 60% | 51% | 36% |
| 9 | 96% | 96% | 95% | 79% | 61% | 60% | 51% | 36% |
| 13 | 96% | 96% | 95% | 79% | 61% | 60% | 51% | 36% |
| 18 | 96% | 96% | 95% | 79% | 61% | 60% | 51% | 36% |
| 21 | 96% | 96% | 95% | 79% | 61% | 60% | 51% | 36% |

The simulation result for the variation of the transfer ratio of imaging light for z/TC is shown in Table 14.

TABLE 14

| | z/TC | | | | |
|---|---|---|---|---|---|
| VIEW ANGLE | 0.303 | 0.245 | 0.239 | 0.192 | 0.091 |
| 6.12 | 33% | 50% | 53% | 79% | 112% |
| 0.5 | 33% | 50% | 53% | 79% | 112% |
| 3 | 33% | 50% | 53% | 79% | 112% |
| 9 | 33% | 50% | 53% | 79% | 112% |
| 13 | 33% | 50% | 53% | 79% | 112% |
| 18 | 33% | 50% | 53% | 79% | 112% |
| 21 | 33% | 50% | 53% | 79% | 112% |

The simulation result for the variation of the transmissibility of the amount of light for V=RO/((TC−z))tan θ) is shown in Table 15.

TABLE 15

| VIEW | V | | | | | | | | |
|---|---|---|---|---|---|---|---|---|---|
| ANGLE | 0.278 | 0.328 | 0.364 | 0.410 | 0.456 | 0.547 | 0.638 | 0.729 | 0.911 |
| 6.12 | 50% | 59% | 65% | 72% | 79% | 79% | 79% | 79% | 79% |
| 0.5 | 50% | 59% | 65% | 72% | 79% | 79% | 79% | 79% | 79% |
| 3 | 50% | 59% | 65% | 72% | 79% | 79% | 79% | 79% | 79% |
| 9 | 50% | 59% | 65% | 72% | 79% | 79% | 79% | 79% | 79% |
| 13 | 50% | 59% | 65% | 72% | 79% | 79% | 79% | 79% | 79% |
| 18 | 50% | 59% | 65% | 72% | 79% | 79% | 79% | 79% | 79% |
| 21 | 50% | 59% | 65% | 72% | 79% | 79% | 79% | 79% | 79% |

When the ranges of value such that the brightness is 50% or more are found out from Tables 10-15, the conditions for design values capable of realizing an imaging optical system in which the brightness is 50% or more may be obtained.

The conditions for causing the brightness to be 50% or more are as follows. The value of d is of 0.255≦d. The value of P/D is of 1.678>P/D. The value of e is of 0.768>e. The value of S/TC is of 0.144<S/TC. The value of z/TC is of 0.254≦z/TC. When the width of the lens array width is represented by RO, The value of V=RO/((TC−z)×tan θ) is of 0.278≦V.

The value of d is of 0.255≦d, the value of e is of 0.768>e, the value of S/TC is of 0.144<S/TC, the value of z/TC is of 0.254≦z/TC, the value of V is of 0.278≦V, and the value of DL/P is of 0.750≦DL/P<1.

2. Presence of a Slit, Outside-Formed Type Light-Shielding Wall Provided Only on the Side of the Image Reading Plane or the Image Writing Plane:

The simulation result for the variation of the amount of stray light/the amount of transferred imaging light for e=(h/DM)×tan θ×(P/1.25D) is shown in Table 16.

TABLE 16

| | e | | | | | | | |
|---|---|---|---|---|---|---|---|---|
| VIEW ANGLE | 0.000 | 0.024 | 0.048 | 0.071 | 0.095 | 0.108 | 0.119 | 0.128 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value are found out from Table 16 shown in the above Tables 5, 6, 7, and 8 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The lens arrangement of the lens array plate is hexagonal arrangement. The light-shielding wall is provided only on the lens array plate on the side of the image reading plane or the image writing plane. The view angle θ is of 0°<θ≦21°. The inclined angle φ is of 9°<φ27°, in particular, 11°≦φ<17° for 0°<θ<3°, and 10°≦φ<16° for 3°≦θ<9°. The value of c is of 0.466≦c<1.767, in particular 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7<DL/P<0.950. The value of e is of 0<e, in particular, 0.108≦e for 0°<θ<6.12°, and 0.048≦e for 6.12°≦θ<9°.

The conditions for causing the amount of stray light at respective view angles to be 0% are as follows. The lens arrangement of the lens array plate is hexagonal arrangement. The light-shielding wall is provided only on the lens array plate on the side of the image reading plane or the image writing plane. The view angle θ is of

0°<θ≦21°. The inclined angle φ is of 11°<φ≦25°, in particular, 11°≦φ<17° for 0°<θ<6.12°, and 12°≦φ<17° for 6.12°≦θ<9°. The value of c is of 0.466≦c<1.492. The value of P/D is of 1.034≦P/D<2.157, in particular, 1.142≦P/D<2.157 for 0°<θ<9°, and 1.180≦P/D<2.157 for 9°≦θ<21°. The value of DL/P is of 0.7≦DL/P<0.950. The value of e is of 0.071≦e, in particular, 0.108≦e for 0°<θ<6.12°, and 0.095≦e for 9°≦θ<21°.

The conditions for causing the amount of stray light at all of view angles to be 10% or less are as follows. The lens arrangement of the lens array plate is hexagonal arrangement. The light-shielding wall is provided on the lens array plate only on the side of the image reading plane or the image writing plane. The view angle θ is of 0°<θ≦21°. The inclined angle φ is of 11°≦φ≦16°. The value of c is of 0.466≦c<1.327. The value of P/D is of 1.142≦P/D<2.157. The value of DL/P is of 0.7≦DL/P<0.950. The value of e is of 0.108≦e.

The conditions for causing the amount of stray light at all of view angles to be 0% as follows. The lens arrangement of the lens array plate is hexagonal arrangement. The light-shielding wall is provided only on the lens array plate on the side of the image reading plane or the image writing plane. The view angle θ is of 0°<θ≦21°. The inclined angle φ is of 12°≦φ≦16°. The value of c is of 0.466≦c<1.327. The value of P/D is of 1.180≦P/D<2.157. The value of DL/P is of 0.7≦DL/P<0.950. The value of e is of 0.108≦e.

When the ranges of value such that the brightness is 50% or more are found out from Tables 10, 11, 12, 13, 14,and 15 shown hereinbefore, the conditions for design values capable of realizing an imaging optical system in which the brightness is 50% or more may be obtained.

The conditions for causing the brightness to be 50% or more are as follows. The value of d is of 0.255≦d. The value of P/D is of 1.678>P/D. The value of e is of 0.768>e. The value of S/TC is of 0.144<S/TC. The value of z/TC is of 0.254≦z/TC. The value of V is of 0.278≦V. The value of DL/P is of 0.750≦DL/P.

3. Presence of a Slit, Outside-Formed Type Light-Shielding Walls Provided on the Side of the Object Plane and on the Side of the Image Reading Plane or the Image Writing Plane:

The simulation result for the variation of the amount of stray light/the amount of transferred imaging light for e=(h/DM)×tan θ×(P/1.25D) is shown in Table 17.

TABLE 17

| | e | | | | | | | |
|---|---|---|---|---|---|---|---|---|
| VIEW ANGLE | 0.000 | 0.014 | 0.030 | 0.044 | 0.058 | 0.066 | 0.073 | 0.079 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value are found out from Table 17 shown above and Tables 5, 6, 7, and 8 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed may be obtained.

The conditions for causing the amount of stray light at respective view angles to be 10% or less are as follows. The lens arrangement of the lens array plate is hexagonal arrangement. The light-shielding walls are provided on the lens array plate on the sides of the image reading plane or the image writing plane and on the lens array plate on the sides of the object plane. The view angle θ is of 0°<θ21°. The inclined angle φ is of 9°<φ≦27°, in particular, 11°≦φ<17° for 0°<θ<3°, and 10°≦φ<16° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.066≦e for 0°<θ<6.12°, and 0.03≦e for 6.12°≦θ<9°.

The conditions for causing the amount of stray light at respective view angles to be 0% are as follows. The lens arrangement of the lens array plate is hexagonal arrangement. The light-shielding walls are provided on the lens array plate on the sides of the image reading plane or the image writing plane and on the lens array plate on the sides of the object plane. The view angle θ is of 0°<θ<21°. The inclined angle φ is of 11°≦φ<25°, in particular, 11°≦φ<17° for 0°<θ<6.12°, and 12°≦φ<17° for 6.12°≦θ<9°. The value of c is of 0.466≦c<1.492. The value of P/D is of 1.034≦P/D<2.157, in particular, 1.142≦P/D<2.157 for 0°<θ<9°, 1.180≦P/D<2.157 for 9°≦θ<21°. The value of DL/P is of 0.7≦DL/P<0.950. The value of e is of 0.044≦e, in particular, 0.066≦e for 0°<θ<6.12°, and 0.058≦e for 9°≦θ<21°.

The conditions for causing the amount of stray light at all of view angles to be 10% or less are as follows. The lens arrangement of the lens array plate is hexagonal arrangement. The light-shielding walls are provided on the lens array plate on the sides of the image reading plane or the image writing plane and on the lens array plate on the sides of the object plane. The view angle θ is of 0°<θ≦21°. The inclined angle φ is of 11°≦φ<16°. The value of c is of 0.466≦c<1.327. The value of P/D is of 1.142≦P/D<2.157. The value of DL/P is of 0.7≦DL/P<0.950. The value of e is of 0.066≦e.

The conditions for causing the amount of stray light at all of view angles to be 0% are as follows. The lens arrangement of the lens array plate is hexagonal arrangement. The light-shielding walls are provided on the lens array plate on the sides of the image reading plane or the image writing plane and on the lens array plate on the sides of the object plane. The view angle θ is of 0°<θ≦21°. The inclined angle φ is of 12°≦φ<16°. The value of c is of 0.466≦c<1.327. The value of P/D is of 1.180≦P/D<2.157. The value of DL/P is of 0.7≦DL/P<0.950. The value of e is of 0.066≦e.

The simulation result for the variation of the transfer ratio of imaging light for e=(h/DM)×tan θ×(P/1.25D) is shown in Table 18.

TABLE 18

| | e | | | | | | |
|---|---|---|---|---|---|---|---|
| VIEW ANGLE | 0.103 | 0.288 | 0.384 | 0.444 | 0.479 | 0.574 | 0.768 |
| 6.12 | 77% | 65% | 55% | 50% | 47% | 34% | 13% |
| 0.5 | 77% | 65% | 55% | 50% | 47% | 34% | 13% |
| 3 | 77% | 65% | 55% | 50% | 47% | 34% | 13% |
| 9 | 77% | 65% | 55% | 50% | 47% | 34% | 13% |
| 13 | 77% | 65% | 55% | 50% | 47% | 34% | 13% |
| 18 | 77% | 65% | 55% | 50% | 47% | 34% | 13% |
| 21 | 77% | 65% | 55% | 50% | 47% | 34% | 13% |

When the ranges of value such that the brightness is 50% or more are found out from Table 18 shown above and Tables10, 11, 13, 14, and 15 shown hereinbefore, the conditions for design values capable of realizing an imaging optical system in which the brightness is 50% or more may be obtained.

The conditions for causing the brightness to be 50% or more are as follows. The value of d is of 0.255≦d. The value of P/D is of 1.678>P/D. The value of e is of 0.479>e. The value of S/TC is of 0.144<S/TC. The value of z/TC is of 0.254≦z/TC. The value of V is of 0.278≦V. The value of DL/P is of 0.750≦DL/P.

4. Presence of a Slit, Inside-Formed Type Light-Shielding Wall Provided Only on the Side of the Object Plane:

The simulation result for the variation of the amount of stray light/the amount of transferred imaging light for e=(h/DM)×tan θ×(P/1.25D) is shown in Table 19.

TABLE 19

| | e | | | | | | | |
|---|---|---|---|---|---|---|---|---|
| VIEW ANGLE | 0.000 | 0.015 | 0.031 | 0.046 | 0.062 | 0.071 | 0.078 | 0.084 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value are found out from Table 19 shown above and Tables 5, 6, 7, and 8 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed may be obtained.

The conditions for causing the amount of stray light at respective view angles to be 10% or less are as follows. The lens arrangement of the lens array plate is hexagonal arrangement. The light-shielding walls are provided only inside the lens array plate on the side of the object plane. The view angle θ is of 0°<θ≦21°. The inclined angle φ is of 9°<φ27°, in particular, 11°≦φ<17° for 0°<θ<3°, and 10°≦φ<16° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.071≦e for 0°<θ<6.12°, and 0.031≦e for 6.12°≦θ<9°.

The conditions for causing the amount of stray light at respective view angles to be 0% are as follows. The lens arrangement of the lens array plate is hexagonal arrangement. The light-shielding walls are provided only inside the lens array plate on the side of the object plane. The view angle θ is of 0°<θ≦21°. The inclined angle φ is of 11°≦φ<25°, in particular, 11°≦φ<17° for 0°<θ<6.12°, and 12°≦φ<17° for 6.12≦θ<9°. The value of c is of 0.466≦c<1.492. The value of P/D is of 1.034≦P/D<2.157, in particular, 1.142≦P/D<2.157 for 0°<θ<9°, and 1.180≦P/D<2.157 for 9°≦θ<21°. The value of DL/P is of 0.7≦DL/P<0.950. The value of e is of 0.046≦e, in particular, 0.071≦e for 0°<θ<6.12°, and 0.062≦e for 9°≦θ<21°.

The conditions for causing the amount of stray light at all of view angles to be 10% or less are as follows. The lens arrangement of the lens array plate is hexagonal arrangement. The light-shielding walls are provided only inside the lens array plate on the side of the object plane. The view angle θ is of 0°<θ≦21°. The inclined angle φ is of 11°≦φ<16°. The value of c is of 0.466≦c<1.327. The value of P/D is of 1.142≦P/D<2.157. The value of DL/P is of 0.7≦DL/P<0.950. The value of e is of 0.071≦e.

The conditions for causing the amount of stray light at all of view angles to be 0% are as follows. The lens arrangement of the lens array plate is hexagonal arrangement. The light-shielding walls are provided only inside the lens array plate on the side of the object plane. The view angle θ is of 0°<θ≦21°. The inclined angle φ is of 12°≦φ<16°. The value of c is of 0.466≦c<1.327. The value of P/D is of 1.180≦P/D<2.157. The value of DL/P is of 0.7≦DL/P<0.950. The value of e is of 0.071≦e.

5. Presence of a Slit, Inside-Formed Type Light-Shielding Wall Provided Only on the Side of the Image Reading Plane or the Image Writing Plane:

The simulation result for the variation of the amount of stray light/the amount of transferred imaging light for e=(h!DM)×tan θ×(P/1.25D) is shown in Table 20.

TABLE 20

| | e | | | | | | | |
|---|---|---|---|---|---|---|---|---|
| VIEW ANGLE | 0.000 | 0.015 | 0.031 | 0.046 | 0.062 | 0.071 | 0.078 | 0.084 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value are found out from Table 20 shown above and Tables 5, 6, 7, and 8 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed may be obtained.

The conditions for causing the amount of stray light at respective view angles to be 10% or less are as follows. The lens arrangement of the lens array plate is hexagonal arrangement. The light-shielding wall is provided only inside the lens array plate on the side of the image reading plane or the image writing plane. The view angle θ is of 0°<θ≦21°. The inclined angle φ is of 9°<φ27°, in particular, 11°≦φ<17° for 0°<θ<3°, and 10°≦φ<16° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.071≦e for 0°<θ<6.12°, and 0.031≦e for 6.12°≦θ<9°.

The conditions for causing the amount of stray light at respective view angles to be 0% are as follows. The lens arrangement of the lens array plate is hexagonal arrangement. The light-shielding walls is provided only inside the lens array plate on the side of the image reading plane or the image writing plane. The view angle θ is of 0°<θ≦21°. The inclined angle φ is of 11°≦φ<25°, in particular, 11<φ<17° for 0°<θ<6.12°, and 12°≦φ<17° for 6.12°≦θ<9°. The value of c is of 0.466≦c<1.492. The value of P/D is of 1.034≦P/D<2.157, in particular, 1.142≦P/D<2.157 for 0°<θ<9°, and 1.180≦P/D<2.157 for 9°≦θ<21°. The value of DL/P is of 0.7<DL/P<0.950. The value of e is of 0.046≦e, in particular, 0.071≦e for 0°<θ<6.12°, and 0.062≦e for 9°≦θ<21°.

The conditions for causing the amount of stray light at all of view angles to be 10% or less are as follows. The lens arrangement of the lens array plate is hexagonal arrangement. The light-shielding walls are provided inside the lens array plate on the side of the image reading plane or the image writing plane. The view angle θ is of 0°<θ≦21°. The inclined angle φ is of 11°≦φ<16°. The value of c is of 0.466≦c<1.327. The value of P/D is of 1.142≦P/D<2.157. The value of DL/P is of 0.7≦DL/P<0.950. The value of e is of 0.071≦e.

The conditions for causing the amount of stray light at all of view angles to be 0% are as follows. The lens arrangement of the lens array plate is hexagonal arrangement. The light-shielding walls are provided only inside the lens array plate on the side of the image reading plane or the image writing plane. The view angle θ is of 0°<θ≦21°. The inclined angle φ is of 12°≦φ<16°. The value of c is of 0.466≦c<1.327. The value of P/D is of 1.180≦P/D<2.157. The value of DL/P is of 0.7≦DL/P<0.950. The value of e is of 0.071≦e.

6. Presence of a Slit, Inside-Formed Type Light-Shielding Walls Provided on Both Sides of the Object Plane and the Image Reading Plane or the Image Writing Plane:

The simulation result for the variation of the amount of stray light/the amount of transferred imaging light for e=(h/DM)×tan θ×(P/1.25D) is shown in Table 21.

TABLE 21

| | e | | | | | | | |
|---|---|---|---|---|---|---|---|---|
| VIEW ANGLE | 0.000 | 0.014 | 0.028 | 0.041 | 0.055 | 0.062 | 0.069 | 0.074 |
| 6.12 | 17% | 13% | 6% | 0% | 0% | 0% | 0% | 0% |
| 0.5 | 210% | 160% | 83% | 60% | 25% | 0% | 0% | 0% |
| 3 | 114% | 76% | 43% | 30% | 10% | 0% | 0% | 0% |
| 9 | 1% | 1% | 1% | 1% | 0% | 0% | 0% | 0% |
| 13 | 1% | 1% | 1% | 1% | 0% | 0% | 0% | 0% |
| 18 | 1% | 1% | 1% | 1% | 0% | 0% | 0% | 0% |
| 21 | 1% | 1% | 1% | 1% | 0% | 0% | 0% | 0% |

When the ranges of value are obtained from Table 21 shown above and Tables 5, 6, 7, and 8 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed may be obtained.

The conditions for causing the amount of stray light at respective view angles to be 10% or less are as follows. The lens arrangement of the lens array plate is hexagonal arrangement. The light-shielding walls are provided inside the lens array plate on the side of the object plane and inside the lens array plate on the side of the image reading plane or the image reading plane. The view angle θ is of 0°<θ≦21°. The inclined angle φ is of 9°<φ≦27°, in particular, 11°≦φ<17° for 0°<θ3°, and 10°≦φ<16° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.062≦e for 0°<θ<6.12°, and 0.028≦e for 6.12°≦θ<9°.

The conditions for causing the amount of stray light at respective view angles to be 0% are as follows. The lens arrangement of the lens array plate is hexagonal arrangement. The light-shielding walls are provided inside the lens array plate on the side of the object plane and inside the lens array plate on the side of image reading plane or the image writing plane. The view angle θ is of 0°<θ≦21°. The inclined angle φ is of 11°≦φ<25°, in particular, 11°≦φ<17° for 0°<θ<6.12°, and 12°≦φ<17° for 6.12°≦θ<9°. The value of c is of 0.466≦c<1.492. The value of P/D is of 1.034≦P/D<2.157, in particular, 1.142≦P/D<2.157 for 0°<θ<9°, and 1.180≦P/D<2.157 for 9°≦θ<21. The value of DL/P is of 0.7≦DL/P<0.950. The value of e is of 0.041≦e, in particular, 0.062≦e for 0°<θ<6.12°, and 0.055≦e for 9°≦θ<21°.

The conditions for causing the amount of stray light at all of view angles to be 10% or less are as follows. The lens arrangement of the lens array plate is hexagonal arrangement. The light-shielding walls are provided inside the lens array plate on the side of the object plane and inside the lens array plate on the side of image reading plane or the image writing plane. The view angle θ is of 0°<θ≦21°. The inclined angle φ is of 11°≦φ<16°. The value of c is of 0.466≦c<1.327. The value of P/D is of 1.142≦P/D<2.157. The value of DL/P is of 0.7≦DL/P<0.950. The value of e is of 0.062≦e.

The conditions for causing the amount of stray light at all of view angles to be 0% are as follows. The lens arrangement of the lens array plate is hexagonal arrangement. The light-shielding walls are provided inside the lens array plate on the side of the object plane and inside the lens array plate on the side of image reading plane or the image writing plane. The view angle θ is of 0°<θ≦21°. The inclined angle φ is of 12°≦φ<16°. The value of c is of 0.466≦c<1.327. The value of P/D is of 1.180≦P/D<2.157. The value of DL/P is of 0.7≦DL/P<0.950. The value of e is of 0.062≦e.

7. Absence of a Slit, Outside-Formed Type Light-Shielding Wall Provided Only on the Side of the Object Plane:

The simulation result for the variation of the amount of stray light/the amount of transferred imaging light for P/D is shown in Table 22.

TABLE 22

| VIEW | P/D | | | | | | | | |
|---|---|---|---|---|---|---|---|---|---|
| ANGLE | 1.034 | 1.142 | 1.180 | 1.216 | 1.250 | 1.450 | 1.570 | 1.678 | 2.157 |
| 6.12 | 9% | 0% | 0% | 0% | 0% | 0% | 0% | 0% | 0% |
| 0.5 | 101% | 0% | 0% | 0% | 0% | 0% | 0% | 0% | 0% |
| 3 | 55% | 0% | 0% | 0% | 0% | 0% | 0% | 0% | 0% |
| 9 | 5% | 2% | 0% | 0% | 0% | 0% | 0% | 0% | 0% |
| 13 | 4% | 2% | 0% | 0% | 0% | 0% | 0% | 0% | 0% |
| 18 | 2% | 1% | 0% | 0% | 0% | 0% | 0% | 0% | 0% |
| 21 | 0% | 0% | 0% | 0% | 0% | 0% | 0% | 0% | 0% |

The simulation result for the variation of the amount of stray light/the amount of transferred imaging light for e=(h/DM)×tan θ×(P/1.25D) is shown in Table 23.

TABLE 23

| | e | | | | | | |
|---|---|---|---|---|---|---|---|
| VIEW ANGLE | 0.402 | 0.479 | 0.498 | 0.517 | 0.537 | 0.574 | 0.768 |
| 6.12 | 11% | 3% | 0% | 0% | 0% | 0% | 0% |
| 0.5 | 11% | 3% | 0% | 0% | 0% | 0% | 0% |
| 3 | 11% | 3% | 0% | 0% | 0% | 0% | 0% |
| 9 | 11% | 3% | 0% | 0% | 0% | 0% | 0% |
| 13 | 11% | 3% | 0% | 0% | 0% | 0% | 0% |
| 18 | 11% | 3% | 0% | 0% | 0% | 0% | 0% |
| 21 | 11% | 3% | 0% | 0% | 0% | 0% | 0% |

When the ranges of value are found out from Tables 22 and 23 shown above such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding wall is provided only on the lens array plate on the side of the object plane. The view angle θ is of 0°<θ≦21°. The value of P/D is of 1.034≦P/D, in particular, 1.142≦P/D for 0°<θ<6.12°. The value of e is of 0.479<e.

The conditions for causing the amount of stray light at respective view angles to be 0% are as follows. The light-shielding wall is provided only on the lens array plate on the side of the object plane. The view angle θ is of 0°<θ≦21°. The value of P/D is of 1.034≦P/D, in particular, 1.142≦P/D for 0°<θ<9°, and 1.180≦P/D for 9°≦θ<21. The value of e is of 0.498≦e.

The conditions for causing the amount of stray light at all of view angles to be 10% or less are as follows. The light-shielding wall is provided only on the lens array plate on the side of the object plane. The view angle θ is of 0°<θ≦21°. The value of P/D is of 1.142≦P/D. The value of e is of 0.0479≦e.

The conditions for causing the amount of stray light at all of view angles to be 0% are as follows. The light-shielding wall is provided only on the lens array plate on the side of the object plane. The view angle θ is of 0°<θ≦21°. The value of P/D is of 1.180≦P/D. The value of e is of 0.498≦e.

The simulation result for the variation of the transfer ratio of imaging light for P/D is shown in Table 24.

TABLE 24

| VIEW | P/D | | | | | | | | |
|---|---|---|---|---|---|---|---|---|---|
| ANGLE | 1.034 | 1.142 | 1.180 | 1.216 | 1.250 | 1.450 | 1.570 | 1.678 | 2.157 |
| 6.12 | 116% | 95% | 89% | 84% | 79% | 59% | 50% | 40% | 30% |
| 0.5 | 116% | 95% | 89% | 84% | 79% | 59% | 50% | 40% | 30% |
| 3 | 116% | 95% | 89% | 84% | 79% | 59% | 50% | 40% | 30% |
| 9 | 116% | 95% | 89% | 84% | 79% | 59% | 50% | 40% | 30% |
| 13 | 116% | 95% | 89% | 84% | 79% | 59% | 50% | 40% | 30% |
| 18 | 116% | 95% | 89% | 84% | 79% | 59% | 50% | 40% | 30% |
| 21 | 116% | 95% | 89% | 84% | 79% | 59% | 50% | 40% | 30% |

When the ranges of value such that the brightness is 50% or more are found out from Table 24 shown above and Table 8 shown hereinbefore, the conditions for design values capable of realizing an imaging optical system in which the brightness is 50% or more may be obtained.

The conditions for causing the brightness to be 50% or more are as follows. The value of P/D is of 1.678>P/D. The value of DL/P is of 0.750≦DL/P.

8. Absence of a Slit, Outside-Formed Type Light-Shielding Wall Provided Only on the Side of the Image Reading Plane or the Image Writing Plane:

The simulation result for the variation of the amount of stray light/the amount of transferred imaging light for e=(h/DM)×tan θ×(P/1.25D) is shown in Table 25.

TABLE 25

| | e | | | | | | |
|---|---|---|---|---|---|---|---|
| VIEW ANGLE | 0.402 | 0.479 | 0.498 | 0.517 | 0.537 | 0.574 | 0.768 |
| 6.12 | 11% | 3% | 0% | 0% | 0% | 0% | 0% |
| 0.5 | 11% | 3% | 0% | 0% | 0% | 0% | 0% |
| 3 | 11% | 3% | 0% | 0% | 0% | 0% | 0% |
| 9 | 11% | 3% | 0% | 0% | 0% | 0% | 0% |
| 13 | 11% | 3% | 0% | 0% | 0% | 0% | 0% |
| 18 | 11% | 3% | 0% | 0% | 0% | 0% | 0% |
| 21 | 11% | 3% | 0% | 0% | 0% | 0% | 0% |

When the ranges of value are found out from Table 25 shown above and Table 22 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding wall is provided only on the lens array plate on the side of the image reading plane or the image writing plane. The view angle θ is of 0°<θ≦21°. The value of P/D is of 1.034≦P/D, in particular, 1.142≦P/D for 0°<θ<6.12°. The value of e is of 0.479≦e.

The conditions for causing the amount of stray light at respective view angles to be 0% are as follows. The light-shielding wall is provided only on the lens array plate on the side of the image reading plane or the image writing plane. The view angle θ is of 0°<θ≦21°. The value of P/D is of 1.034≦P/D, in particular, 1.142≦P/D for 0°<θ<9°, and 1.180≦P/D for 9°≦θ<21. The value of e is of 0.498≦e.

The conditions for causing the amount of stray light at all of view angles to be 10% or less are as follows. The light-shielding wall is provided only on the lens array plate on the side of the image reading plane or the image writing plane. The view angle θ is of 0°<θ≦21°. The value of P/D is of 1.142≦P/D. The value of e is of 0.0479≦e.

The conditions for causing the amount of stray light at all of view angles to be 0% are as follows. The light-shielding wall is provided only on the lens array plate on the side of the image reading plane or the image writing plane. The view angle θ is of 0°<θ≦21°. The value of P/D is of 1.180≦P/D. The value of e is of 0.498≦e.

The simulation result for the variation of the transfer ratio of imaging light for z/TC is shown in Table 26.

TABLE 26

| | z/TC | | | | |
|---|---|---|---|---|---|
| VIEW ANGLE | 0.303 | 0.245 | 0.239 | 0.192 | 0.091 |
| 6.12 | 33% | 50% | 53% | 79% | 112% |
| 0.5 | 33% | 50% | 53% | 79% | 112% |
| 3 | 33% | 50% | 53% | 79% | 112% |
| 9 | 33% | 50% | 53% | 79% | 112% |
| 13 | 33% | 50% | 53% | 79% | 112% |
| 18 | 33% | 50% | 53% | 79% | 112% |
| 21 | 33% | 50% | 53% | 79% | 112% |

When the ranges of value such that the brightness is 50% or more are found out from Table 26 shown above and Tables 24 and 8 shown hereinbefore, the conditions for design values capable of realizing an imaging optical system in which the brightness is 50% or more may be obtained.

The conditions for causing the brightness to be 50% or more are as follows. The value of z/TC is of 0.245≦z/TC. The value of P/D is of 1.678>P/D. The value of DL/P is of 0.750≦DL/P.

9. Absence of a Slit, Outside-Formed Type Light-Shielding Walls Provided on the Side of the Object Plane and on the Side of the Image Reading Plane or the Image Writing Plane:

The simulation result for the variation of the amount of stray light/the amount of transferred imaging light for e=(h/DM)×tan θ×(P/1.25D) is shown in Table 27.

TABLE 27

| | e | | | | | | | | | | | | |
|---|---|---|---|---|---|---|---|---|---|---|---|---|---|
| VIEW ANGLE | 0.268 | 0.287 | 0.307 | 0.326 | 0.347 | 0.384 | 0.402 | 0.479 | 0.498 | 0.517 | 0.537 | 0.574 | 0.768 |
| 6.12 | 11% | 1% | 0% | 0% | 0% | 0% | 0% | 0% | 0% | 0% | 0% | 0% | 0% |
| 0.5 | 11% | 1% | 0% | 0% | 0% | 0% | 0% | 0% | 0% | 0% | 0% | 0% | 0% |
| 3 | 11% | 1% | 0% | 0% | 0% | 0% | 0% | 0% | 0% | 0% | 0% | 0% | 0% |
| 9 | 11% | 1% | 0% | 0% | 0% | 0% | 0% | 0% | 0% | 0% | 0% | 0% | 0% |
| 13 | 11% | 1% | 0% | 0% | 0% | 0% | 0% | 0% | 0% | 0% | 0% | 0% | 0% |
| 18 | 11% | 1% | 0% | 0% | 0% | 0% | 0% | 0% | 0% | 0% | 0% | 0% | 0% |
| 21 | 11% | 1% | 0% | 0% | 0% | 0% | 0% | 0% | 0% | 0% | 0% | 0% | 0% |

When the ranges of value are found out from Table 27 shown above and Table 22 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding walls are provided on the lens array on the side of the object plane and on the lens array on the side of the image reading plane or the image writing plane. The view angle θ is of 0°<θ≦21°. The value of P/D is of 1.034≦P/D, in particular, 1.142≦P/D for 0°<θ<6.12°. The value of e is of 0.287≦e.

The conditions for causing the amount of stray light at respective view angles to be 0% are as follows. The light-shielding walls are provided on the lens array on the side of the object plane and on the lens array on the side of the image reading plane or the image writing plane. The view angle θ is of 0°<θ≦21°. The value of P/D is of 1.034≦P/D, in particular, 1.142≦P/D for 0°<θ<9°, and 1.180≦P/D for 9°≦θ<21°. The value of e is of 0.307≦e.

The conditions for causing the amount of stray light at all of view angles to be 10% or less are as follows. The light-shielding walls are provided on the lens array on the side of the object plane and on the lens array on the side of the image reading plane or the image writing plane. The view angle θ is of 0°<θ≦21°. The value of P/D is of 1.142≦P/D. The value of e is of 0.287≦e.

The conditions for causing the amount of stray light at all of view angles to be 0% are as follows. The light-shielding walls are provided on the lens array on the side of the object plane and on the lens array on the side of the image reading plane or the image writing plane. The view angle θ is of 0°<θ≦21°. The value of P/D is of 1.180≦P/D. The value of e is of 0.307≦e.

The simulation result for the variation of the transfer ratio of imaging light for e=(h/DM)×tan θ×(P/1.25D) is shown in Table 28.

TABLE 28

| | e | | | | | | | |
|---|---|---|---|---|---|---|---|---|
| VIEW ANGLE | 0.103 | 0.287 | 0.307 | 0.384 | 0.537 | 0.558 | 0.574 | 0.768 |
| 6.12 | 93% | 79% | 77% | 67% | 55% | 50% | 47% | 16% |
| 0.5 | 93% | 79% | 77% | 67% | 55% | 50% | 41% | 16% |
| 3 | 93% | 79% | 77% | 67% | 55% | 50% | 41% | 16% |
| 9 | 93% | 79% | 77% | 67% | 55% | 50% | 41% | 16% |
| 13 | 93% | 79% | 77% | 67% | 55% | 50% | 41% | 16% |
| 18 | 93% | 79% | 77% | 67% | 55% | 50% | 41% | 16% |
| 21 | 93% | 79% | 77% | 67% | 55% | 50% | 41% | 16% |

When the ranges of value such that the brightness is 50% or more are found out from Table 28 shown above and Tables 24 and 8 shown hereinbefore, the conditions for design values capable of realizing an imaging optical system in which the brightness is 50% or more may obtained.

The conditions for causing the brightness to be 50% or more are as follows. The value of P/D is of 1.678>P/D. The value of e is of 0.574>e. The value of DL/P is of 0.750≦DL/P.

10. Absence of a Slit, Inside-Formed Type Light-Shielding Wall Provided Only on the Side of the Object Plane:

The simulation result for the variation of the amount of stray light/the amount of transferred imaging light for e=(h/DM)×tan θ×(P/1.25D) is shown in Table 29.

TABLE 29

| | |
|---|---|
| VIEW | e |

| ANGLE | 0.326 | 0.347 | 0.384 | 0.402 | 0.479 | 0.498 |
|---|---|---|---|---|---|---|
| 6.12 | 11% | 3% | 0% | 0% | 0% | 0% |
| 0.5 | 11% | 3% | 0% | 0% | 0% | 0% |
| 3 | 11% | 3% | 0% | 0% | 0% | 0% |
| 9 | 11% | 3% | 0% | 0% | 0% | 0% |
| 13 | 11% | 3% | 0% | 0% | 0% | 0% |
| 18 | 11% | 3% | 0% | 0% | 0% | 0% |
| 21 | 11% | 3% | 0% | 0% | 0% | 0% |

When the ranges of value are found out from Table 29 shown above and Table 22 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding wall is provided only inside the lens array on the side of the object plane. The view angle θ is of 0°<θ≦21°. The value of P/D is of 1.034≦P/D, in particular, 1.142≦P/D for 0°<θ<6.12°. The value of e is of 0.347≦e.

The conditions for causing the amount of stray light at respective view angles to be 0% are as follows. The light-shielding wall is provided only inside the lens array on the side of the object plane. The view angle θ is of 0°<θ≦21°. The value of P/D is of 1.034≦P/D, in particular, 1.142≦P/D for 0°<θ<9°, and 1.180≦P/D for 9°≦θ<21°. The value of e is of 0.384≦e.

The conditions for causing the amount of stray light at all of view angles to be 10% or less are as follows. The light-shielding wall is provided only inside the lens array on the side of the object plane. The view angle θ is of 0°<θ≦21°. The value of P/D is of 1.142≦P/D. The value of e is of 0.347≦e.

The conditions for causing the amount of stray light at all of view angles to be 0% are as follows. The light-shielding wall is provided only inside the lens array on the side of the object plane. The view angle θ is of 0°<θ≦21°. The value of P/D is of 1.180≦P/D. The value of e is of 0.384≦e.

11. Absence of a Slit, Inside-Formed Type Light-Shielding Wall Provided Only on the Side of the Image Reading Plane or the Image Writing Plane:

The simulation result for the variation of the amount of stray light/the amount of transferred imaging light for e=(h/DM)×tan θ(P/1.25D) is shown in Table 30.

TABLE 30

| | e | | | | | | | |
|---|---|---|---|---|---|---|---|---|
| VIEW ANGLE | 0.287 | 0.307 | 0.326 | 0.347 | 0.384 | 0.402 | 0.479 | 0.498 |
| 6.12 | 11% | 3% | 0% | 0% | 0% | 0% | 0% | 0% |
| 0.5 | 11% | 3% | 0% | 0% | 0% | 0% | 0% | 0% |
| 3 | 11% | 3% | 0% | 0% | 0% | 0% | 0% | 0% |
| 9 | 11% | 3% | 0% | 0% | 0% | 0% | 0% | 0% |
| 13 | 11% | 3% | 0% | 0% | 0% | 0% | 0% | 0% |
| 18 | 11% | 3% | 0% | 0% | 0% | 0% | 0% | 0% |
| 21 | 11% | 3% | 0% | 0% | 0% | 0% | 0% | 0% |

When the ranges of value are found out from Table 30 shown above and Table 22 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding wall is provided only inside the lens array on the side of the image reading plane or the image writing plane. The view angle θ is of 0°<θ≦21°. The value of P/D is of 1.034≦P/D, in particular, 1.142≦P/D for 0°<θ<6.12°. The value of e is of 0.307≦e.

The conditions for causing the amount of stray light at respective view angles to be 0% are as follows. The light-shielding wall is provided only inside the lens array on the side of the image reading plane or the image writing plane. The view angle θ is of 0°<θ≦21°. The value of P/D is of 1.034≦P/D, in particular, 1.142≦P/D for 0°<θ<9°, and 1.180≦P/D for 9°≦θ<21°. The value of e is of 0.326≦e.

The conditions for causing the amount of stray light at all of view angles to be 10% or less are as follows. The light-shielding wall is provided only inside the lens array on the side of the image reading plane or the image writing plane. The view angle θ is of 0°<θ≦21°. The value of P/D is of 1.142≦P/D. The value of e is of 0.307≦e.

The conditions for causing the amount of stray light at all of view angles to be 0% are as follows. The light-shielding wall is provided only inside the lens array on the side of the image reading plane or the image writing plane. The view angle θ is of 0°<θ≦21°. The value of P/D is of 1.180≦P/D. The value of e is of 0.326≦e.

12. Absence of a Slit, Inside-Formed Type Light-Shielding Walls Provided on the Side of the Object Plane and on the Side of the Image Reading Plane or the Image Writing Plane:

The simulation result for the variation of the amount of stray light/the amount of transferred imaging light for e=(h/DM)×tan θ×(P/1.25D) is shown in Table 31.

TABLE 31

| VIEW | e | | | | | | | | |
|---|---|---|---|---|---|---|---|---|---|
| ANGLE | 0.268 | 0.287 | 0.307 | 0.326 | 0.347 | 0.384 | 0.402 | 0.479 | 0.498 |
| 6.12 | 1% | 0% | 0% | 0% | 0% | 0% | 0% | 0% | 0% |
| 0.5 | 1% | 0% | 0% | 0% | 0% | 0% | 0% | 0% | 0% |
| 3 | 1% | 0% | 0% | 0% | 0% | 0% | 0% | 0% | 0% |
| 9 | 1% | 0% | 0% | 0% | 0% | 0% | 0% | 0% | 0% |
| 13 | 1% | 0% | 0% | 0% | 0% | 0% | 0% | 0% | 0% |
| 18 | 1% | 0% | 0% | 0% | 0% | 0% | 0% | 0% | 0% |
| 21 | 1% | 0% | 0% | 0% | 0% | 0% | 0% | 0% | 0% |

When the ranges of value are found out from Table 31 shown above and Table 22 shown hereinbefore such that the amount of stray light at respective view angles is 10% or less, the amount of stray light at respective view angles is 0%, the amount of stray light at all of view angles is 10% or less, and the amount of stray light at all of view angles is 0%, the conditions for design values capable of realizing an imaging optical system in which ghost may be suppressed are obtained.

The conditions for causing the amount of stray light at respective view angles to be 10% or less are as follows. The light-shielding walls are provided inside the lens array on the side of the object plane and inside the lens array on the side of the image reading plane or the image writing plane. The view angle θ is of 0°<θ≦21°. The value of P/D is of 1.034≦P/D, in particular, 1.142≦P/D for 0°<θ<6.12°. The value of e is of 0<e.

The conditions for causing the amount of stray light at respective view angles to be 0% are as follows. The light-shielding walls are provided inside the lens array on the side of the object plane and inside the lens array on the side of the image reading plane or the image writing plane. The view angle θ is of 0°<θ≦21°. The value of P/D is of 1.034≦P/D, in particular, 1.142≦P/D for 0°<θ<9°, and 1.180≦P/D for 9°≦θ<21°. The value of e is of 0.287≦e.

The conditions for causing the amount of stray light at all of view angles to be 10% or less are as follows. The light-shielding walls are provided inside the lens array on the side of the object plane and inside the lens array on the side of the image reading plane or the image writing plane. The view angle θ is of 0°<θ≦21°. The value of P/D is of 1.142≦P/D. The value of e is of 0≦e.

The conditions for causing the amount of stray light at all of view angles to be 0% are as follows. The light-shielding walls are provided inside the lens array on the side of the object plane and inside the lens array on the side of the image reading plane or the image writing plane. The view angle θ is of 0°<θ≦21°. The value of P/D is of 1.180≦P/D. The value of e is of 0.287≦e.

13. Cases of Any Lens Arrangement

In the imaging optical system comprising a slit, the simulations were carried out on condition that the lens arrangement is a hexagonal lens arrangement. The design values in case of any lens arrangement may also be obtained from the simulation results for the hexagonal lens arrangement.

When the angle between adjacent lens arrangement directions is represented by x°, the most preferable inclined angle y° of the lens arrangement directions with the main-scanning direction may be defined by the formula; y°=−0.006630x²+0.809473x−9.700729. While Table 5 shows the data in case of the hexagonal lens arrangement, it has been confirmed by the inventers of the present application that the same data as in Table 5 may be obtained in other lens arrangement such as square lens arrangement, Table 5 showing that the amount of stray light is increased as the inclined angle is varied with respect to the most preferable inclined angle. Therefore, in case of any lens arrangement, the relationship between the inclined angle and the amount of stray light may be obtained by multiplying the inclined angle in Table 5 with (the most preferable inclined angle in case of the hexagonal lens arrangement))(=15°))/y°. From the table formed in this manner, the conditions by which the amount of stray light becomes 10% or less in respective view angles may be obtained.

It is assumed that the light-shielding wall is provided only on the lens array plate on the side of the object plane, the view angle θ is of 0°<θ≦21°, and y°=−0.006630x²+0.809473x−9.700729, wherein x° is the angle between adjacent lens arrangement directions. The inclined angle φ is 9°×y°/15°<φ≦27°×y°/15°, in particular, 11°×y°/15°≦≦φ<17°×y°/15° for 0°<θ<3°, and 10°×y°/15≦φ<16°×y°/15° for 3°≦θ<9°. The value of c is of 0.466≦c<1.767, in particular, 0.466≦c<1.492 for 0°<θ<6.12°. The value of P/D is of 1.034≦D<2.157, in particular, 1.142≦P/D<2.157 for 0°<θ<6.12°. The value of DL/P is of 0.7≦DL/P<0.950. The value of e is of 0<e, in particular, 0.087≦e for 0°<θ<6.12°, and 0.039≦e for 6.12°≦θ<9°.

Alternatively, the light-shielding wall is provided only on the lens array plate on the side of the image reading plane or the image writing plane. The view angle θ is of 0°<θ≦21°. The inclined angle φ is of 9°×y°/15°<φ27°×y°/15°, in particular, 11°×y°/15°≦φ<17°×y°/15° for 0°<θ<3°, and 10°×y°/15°≦φ<16°×y°/15° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.75≦DL/P<0.950. The value of e is of 0<e, in particular, 0.0185≦e for 0°<θ<6.12°, and 0.048≦e for 6.12°≦θ<9°.

Alternatively, the light-shielding walls are provided on the lens array plate on the side of the image reading plane or the image writing plane and on the lens array plate on the side of the object plane. The view angle θ is of 0°<θ≦21°. The inclined angle φ is of 9°×y°/15°φ≦27°×y°/15°, in particular, 11°×y°/15°≦φ<17°×y°/15° for 0<θ<3°, and 10°×y°/15°≦φ<16°×y°/15° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.0665≦e for 0°<θ<6.12°, and 0.035≦e for 6.12°≦θ<9°.

Alternatively, the light-shielding wall is provided only inside the lens array plate on the side of the object plane. The view angle θ is of 0°<θ≦21°. The inclined angle φ is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°. The value of c is of 1.034≦P/D<2.157, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.071≦e for 0°<θ<6.12°, and 0.031≦e for 6.12°≦θ<9°.

Alternatively, the light-shielding wall is provided only inside the lens array plate on the side of the image reading plane or the image writing plane. The view angle θ is of 0°<θ≦21°. The inclined angle φ is of 9°×y°/15°≦φ<27°×y°/15°, in particular, 11°×y°/15°≦φ<17°×y°/15° for 0°<θ<3°, and 10°×y°/15°≦φ<16°×y°/15° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.071≦e for 0°<θ<6.12°, and 0.031≦e for 6.12°≦θ<9°.

Alternatively, the light-shielding walls are provided inside the lens array plate on the side of the object plane and inside the lens array plate on the side of the image reading plane or the image writing plane. The view angle θ is of 0°<θ≦21°. The inclined angle φ is of 9°×y°/15°<φ<27°×y°/15°, in particular, 11°×y°/15°≦φ<17°×y°/15° for 0°<θ<3°, and 10°×y°/15°≦φ<16°×y°/15° for 3°≦θ<9°. The value of c is of 0.466≦c<1.767, in particular, 0.466≦c<1.492 for 0°<θ<6.12°. The value of P/D is of 1.034≦P/D<2.157, in particular, 1.142≦P/D<2.157 for 0°<θ<6.12°. The value of DL/P is of 0.7≦DL/P<0.950. The value of e is of 0<e, in particular, 0.062≦e for 0°<θ<6.12°, and 0.028≦e for 6.12°≦θ<9°.

Subsequently, an embodiment of the image reading apparatus using an erected unit magnification lens array in accordance with the present invention will now described.

(Image Reading Apparatus)

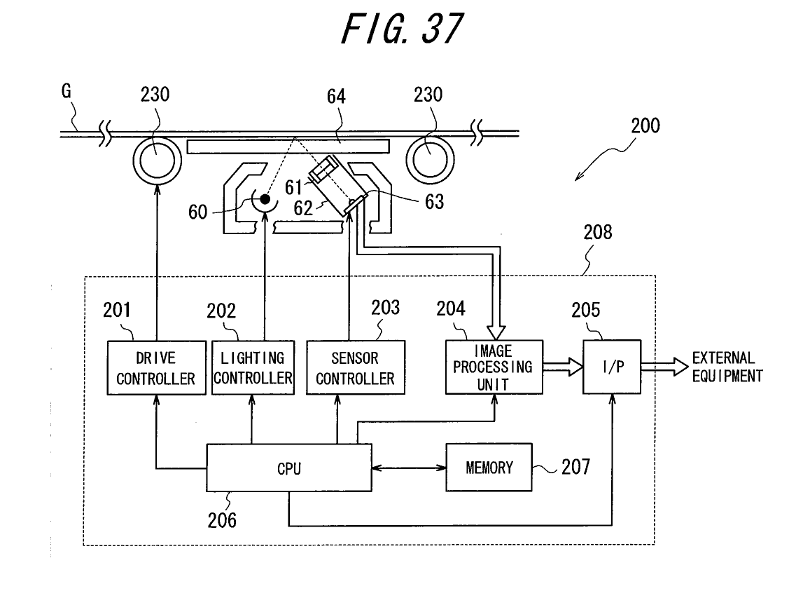

Referring to FIG. 37, there is shown a schematic view of the image reading apparatus using an erected unit magnification lens array in accordance with the present invention. An image scanner 200 which is one of the image reading apparatus comprises a light source 60 for irradiating the light to an original G placed on an original glass plate 64, an image sensor 62 for reading the image information on the original from the light reflected on the original G, a driver 230 for driving the original, and a control circuit 208 for controlling the image scanner. The image sensor 62 comprises a light-receiving element array including a plurality of light-receiving elements for reading the image information on the original by receiving the light reflected on the original G, and an erected unit magnification lens array 61 in accordance with the present invention for imaging the reflected light from the original G on the light-receiving element array.

The control circuit 208 comprises a drive controller 201 for controlling the driving of the driver 230; a lighting controller 202 for controlling the lighting of the light source 60; a sensor controller 203 for controlling a processing unit for receiving the reflected light from the original G by means of the light-receiving element array mounted on an image sensor substrate 63 in the image sensor 62 and converting the received light to an electric signal; an image processing unit 204 for processing the image information obtained by the photoelectric conversion controlled by the sensor controller 203; an interface 205 for outputting the processed image information to an external equipment; a memory 207 for storing programs necessary for image processing, interfacing, and various controlling; and a central processing unit (CPU) 206 for controlling the drive controller 201, the lighting controller 202, the sensor controller 203, the image processing unit 204, the interface 205, and the memory 207.

If the color of the image sensor substrate 63 is selected to be a low brightness color such as black, the light reflection on the image sensor substrate may be prevented, which is effective on the prevention of stray light.

In the image reading apparatus shown in FIG. 37, the reading of the image information on the original G is carried out by driving the original G itself while fixing the image sensor 62. Alternatively, the reading of the image information on the original may be carried out by driving the light source 60 and the image sensor 62 in a sub-scanning direction (in Y direction in the figure) while fixing the original G.

Subsequently, an embodiment of the image writing apparatus using an erected unit magnification lens array in accordance with the present invention will now described.

(Image Writing Apparatus)

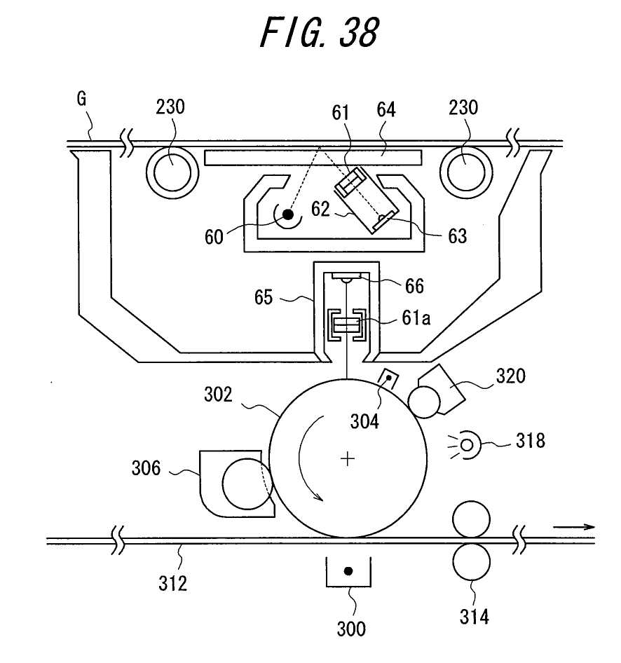

Referring to FIG. 38, there is shown a schematic view of a copy machine which is one of the image writing apparatus using an erected unit magnification lens array in accordance with the present invention. The component in the figure identical to that in FIG. 37 is designated by the same reference numeral as in FIG. 37. Then, the same explanation as in the image scanner will be omitted.

In the copy machine shown in FIG. 38, first, a light-emitting element array 66 in an optical writing head 65 is lit based on the image information from the image sensor. Second, the light from the lit light-emitting element is collected on a photosensitive drum 302 by means of the erected unit magnification lens array 61. On the surface of the photosensitive drum 302, is formed the photoconductive material such as amorphous silicon (photosensitive material). The photosensitive drum is rotated at a speed of printing. The surface of the rotated photosensitive drum is uniformly charged by means of a charger 304. The light ray representing the dot images to be printed is collected on the photosensitive material to erase the charge on the area where the light ray is irradiated. Subsequently, the toner is deposited on the charged photosensitive material by means of a developing unit 306. The toner is transcribed on a driving paper 312 by means of a transcription unit 308. The paper 312 is fixed by applying the heat or the like thereto by means of a fixing unit 314, and then the image information on the original G is finally copied to the paper 312. On the other hand, the charge on the photosensitive drum 302 after completing the transcription is erased across the entire surface thereof by means of an erasing unit 320 so that the residual toner is removed.

While the copy machine has been explained in FIG. 38, the structure of the copy machine may be applied to a composite machine such as a facsimile or a multi-function printer.

Various constitutions of the present invention are listed below.

1. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.087≦e for 0°<θ<6.12°, and 0.039≦e for 6.12°≦θ<9°, wherein h is the height of the light-shielding wall and DM=(DL+D)/2.

2. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the object plane,

the view angle φ of a lens of the lens array is of 0°<θ≦21°,

the angle φ at which the lens arrangement direction of the lens array is inclined with the direction of the longitudinal edge of the lens forming area of the lens array is of 11°≦φ<25°, in particular, 11°≦φ<17° for 0°<θ<6.12°, and 12°≦φ<17° for 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, and 1.180≦P/D<2.157 for 9°≦θ<21°.

the value of DL/P is of 0.75_{—} DL/P <0.950, wherein DL is the lens diameter of an outer lens of the lens array, and

the value of e=(h/DM)×tan θ×(P/1.25D) is of 0.057≦e, in particular, 0.087≦e for 0°<θ<6.12°, and 0.077≦e for 9°≦θ<21°, wherein h is the height of the light-shielding wall and DM=(DL+D)/2.

3. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<17°,

the value of c={a/(2S×tan 2θ×sin 15°)}×(1.25D/P) is of is 0<c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.142≦P/D, and

the value of e=(h/DM)×tan θ×(P/1.25D) is of 0.087≦e, wherein h is the height of the light-shielding wall and DM=(DL+D)/2.

4. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 12°≦φ<17°,

the value of c={a/(2S×tan 2θ×sin 15°)}×(1.25D/P) is of is 0<c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D, and

the value of e=(h/DM)×tan θ×(P/1.25D) is of 0.087≦e, wherein h is the height of the light-shielding wall and DM=(DL+D)/2.

5. An imaging optical system according to any one of items 1-4, wherein

the value of d=a/(2 tan θ×(0.5TC−S)) is of 0.255≦d, wherein TC is the conjugation length of a lens of the lens array,

the value of P/D is of 1.678>P/D,

the value of e is of 0.768>e,

the value of S/TC is of 0.144<S/TC,

the value of z/TC is of 0.245≦z/TC, wherein z is the thickness of a lens of the lens array, and

the value of V=RO/((TC−z)×tan θ) is of 0.278≦V, wherein RO is the width of the lens array.

6. An imaging optical system according to any one of items 1-4, wherein

the value of d=a/(2 tan θ×(0.5TC−S)) is of 0.255≦d, wherein TC is the conjugation length of a lens of the lens array,

the value of e is of 0.768>e,

the value of S/TC is of 0.144<S/TC,

the value of z/TC is of 0.254≦z/TC, wherein z is the thickness of a lens of the lens array, the value of V=RO/((TC−z)×tan θ) is of 0.278≦V, wherein RO is the width of the lens array, and

the value of DL/P is of 0.750≦DL/P<1.

7. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.108≦e for 0°<θ<6.12°, and 0.048≦e for 6.12°≦θ<9°, wherein h is the height of the light-shielding wall and DM=(DL+D)/2.

8. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 11°<φ≦25°, in particular, 11°≦φ<17° for 0°<θ<6.12°, and 12°≦φ<17° for 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, and 1.180≦P/D<2.157 for 9°≦θ<21°,

the value of DL/P is of 0.7≦DL/P<0.950, wherein DL is the lens diameter of an outer lens of the lens array, and

the value of e=(h/DM)×tan θ×(P/1.25D) is of 0.071<e, in particular, 0.108≦e for 0°<θ<6.12°, and 0.0955≦e for 9°≦θ<21°, wherein h is the height of the light and DM=(DL+D)/2.

9. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.142≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.108≦e, wherein h is the height of the light-shielding wall and DM=(DL+D)/2.

10. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only on the lens array on the side of the image reading plane or the image writing plane,

the view angle θ of a lens of the lens array is of 0°<θ≦21°,

the angle Φ at which the lens arrangement direction of the lens array is inclined with the direction of the longitudinal edge of the lens forming area of the lens array is of 12°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.108≦e, wherein h is the height of the light-shielding wall and DM=(DL+D)/2.

11. An imaging optical system according to any one of items 7-10, wherein

the value of d=a/(2 tan θ×(0.5TC−S)) is of 0.255≦d, wherein TC is the conjugation length of a lens of the lens array,

the value of P/D is of 1.678>P/D,

the value of e is of 0.768>e,

the value of S/TC is of 0.144<S/TC,

the value of z/TC is of 0.245≦z/TC, wherein z is the thickness of a lens of the lens array,

the value of V=RO/((TC−z)×tan θ) is of 0.278≦V, wherein RO is the width of the lens array, and

the value of DL/P is of 0.750≦DL/P.

12. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided on the lens array on the side of the image reading plane or the image writing plane and on the lens array on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.066≦e for 0°<θ<6.12°, and 0.03≦e for 6.12°≦θ<9°, wherein h is the height of the light-shielding wall and DM=(DL+D)/2.

13. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided on the lens array on the side of the image reading plane or the image writing plane and on the lens array on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<25°, in particular, 11°≦φ<17° for 0°<θ<6.12°, and 12°≦φ<17° for 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, 1.180≦P/D<2.157 for 9°≦θ<21°,

the value of DL/P is of 0.7≦DL/P<0.950, wherein DL is the lens diameter of an outer lens of the lens array, and

the value of e=(h/DM)×tan θ×(P/1.25D) is of 0.044≦e, in particular, 0.066≦e for 0°<θ<6.12°, and 0.058≦e for 9°≦θ<21°, wherein h is the height of the light-shielding wall and DM=(DL+D)/2.

14. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided on the lens array on the side of the image reading plane or the image writing plane and on the lens array on the side of the object plane,

the view angle θ of a lens of the lens array is of 0°<θ≦21°,

the angle Φ at which the lens arrangement direction of the lens array is inclined with the direction of the longitudinal edge of the lens forming area of the lens array is of 11°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.142≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.066≦e, wherein h is the height of the light-shielding wall and DM=(DL+D)/2.

15. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided on the lens array on the side of the image reading plane or the image writing plane and on the lens array on the side of the object plane,

the view angle θ of a lens of the lens array is of 0°<θ≦21°,

the angle Φ at which the lens arrangement direction of the lens array is inclined with the direction of the longitudinal edge of the lens forming area of the lens array is of 12°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.066≦e, wherein h is the height of the light-shielding wall and DM=(DL+D)/2.

16. An imaging optical system according to any one of items 12-15, wherein the value of d=a/(2 tan θ×(0.5TC−S)) is of 0.255≦d, wherein TC is the conjugation length of a lens of the lens array,

the value of P/D is of 1.678>P/D,

the value of e=(h/DM)×tan θ×(P/1.25D) is of 0.479>e,

the value of S/TC is of 0.144<S/TC,

the value of z/TC is of 0.245≦z/TC, wherein z is the thickness of a lens of the lens array,

the value of V=RO/((TC−z)×tan θ) is of 0.278≦V, wherein RO is the width of the lens array, and

the value of DL/P is of 0.750≦DL/P.

17. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only inside the lens array plate on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

18. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided only inside the lens array plate on the side of the object plane,

the view angle θ of a lens of the lens array is of 0°<θ≦21°,

the angle Φ at which the lens arrangement direction of the lens array is inclined with the direction of the longitudinal edge of the lens forming area of the lens array is of 11°≦φ<25°, in particular, 11°≦φ<17° for 0°≦φ<6.12°, and 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, and 1.180≦P/D<2.157 for 9°≦θ<21°,

the value of DL/P is of 0.7≦DL/P<0.950, wherein DL is the lens diameter of an outer lens of the lens array, and

the value of e=(h/DM)×tan θ×(P/1.25D) is of 0.046≦e, in particular, 0.071≦e for 0°<θ<6.12°, and 0.062≦e for 9°≦θ<21°, wherein h is the height of the light-shielding wall and DM=(DL+D)/2.

19. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided only inside the lens array plate on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.142≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.071≦e, wherein h is the height of the light-shielding wall and DM=(DL+D)/2.

20. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided only inside the lens array plate on the side of the object plane,

the view angle θ of a lens of the lens array is of 0°<θ≦21°,

the angle φ at which the lens arrangement direction of the lens array is inclined with the direction of the longitudinal edge of the lens forming area of the lens array is of 12°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.071≦e, wherein h is the height of the light-shielding wall and DM=(DL+D)/2.

21. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only inside the lens array plate on the side of the image reading plane or the image writing plane,

the view angle θ of a lens of the lens array is of 0°<θ≦21°,

the angle Φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

22. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only inside the lens array plate on the side of the image reading plane or the image writing plane,

the view angle θ of a lens of the lens array is of 0°<θ21°,

the angle φ at which the lens arrangement direction of the lens array is inclined with the direction of the longitudinal edge of the lens forming area is of 11°≦φ<25°, in particular, 11°≦φ<17° for 0°≦φ<6.12°, and 12°≦φ<17° for 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, and 1.180≦P/D<2.157 for 9°≦θ<21°,

the value of DL/P is of 0.7≦DL/P<0.950, wherein DL is the lens diameter of an outer lens of the lens array, and

the value of e=(h/DM)×tan θ×(P/1.25D) is of 0.046≦e, in particular, 0.071≦e for 0°<θ<6.12°, and 0.062≦e for 9°≦θ<21°, wherein h is the height of the light-shielding wall and DM=(DL+D)/2.

23. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area is of 11°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.142≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.071≦e, wherein h is the height of the light-shielding wall and DM=(DL+D)/2.

24. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding wall is provided only inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area is of 12°≦φ<16°,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.071≦e, wherein h is the height of the light-shielding wall and DM=(DL+D)/2.

25. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided inside the lens array plate on the side of the object plane and inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 9°<φ27°, in particular, 11°≦φ<17° for 0°<θ<3°, and 10°≦φ<16° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tanθ×(P/1.25D) is of 0<e, in particular, 0.062≦e for 0°<θ<6.12°, and 0.028≦e for 6.12°≦θ<9°, wherein h is the height of the light-shielding wall and DM=(DL+D)/2.

26. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided inside the lens array plate on the side of the object plane and inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<25°, in particular, 11°≦φ<17° for 0°<θ<6.12°, and 12°≦φ<17° for 6.12°≦θ<9°,

the value of c={a/(2S×tan 2θ×sin 15°)}×(1.25D/P) is of 0.466≦c<1.492, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<9°, and 1.180≦P/D<2.157 for 9°≦θ<21,

the value of DL/P is of 0.7≦DL/P<0.950, wherein DL is the lens diameter of an outer lens of the lens array, and

the value of e=(h/DM)×tan θ×(P/1.25D) is of 0.041≦e, in particular, 0.062≦e for 0°<θ<6.12°, and 0.055≦e for 9°≦θ<21°, wherein h is the height of the light-shielding wall and DM=(DL+D)/2.

27. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided inside the lens array plate on the side of the object plane and inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 11°≦φ<16,

the value of c={a/(2S×tan 2θ×sin 15°)}×(1.25D/P) is of 0.466≦c<1.327, wherein a is the width of the opening of the slit, S is the distance from the center position of lens conjugation length to the slit, P is a lens pitch of the lens array, and D is the lens diameter of an inner lens of the lens array, the value of P/D is of 1.142≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.062≦e, wherein h is the height of the light-shielding wall and DM=(DL+D)/2.

28. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the lens arrangement of the lens array is hexagonal arrangement,

the light-shielding walls are provided inside the lens array plate on the side of the object plane and inside the lens array plate on the side of the image reading plane or the image writing plane,

the view angle θ of a lens of the lens array is of 0°<θ≦21°,

the angle φ at which the lens arrangement direction of the lens array is inclined with the direction of the longitudinal edge of the lens forming area of the lens array is of 12°≦φ<16,

the value of c={a/(2S×tan 2θ×sin 15°)}×(1.25D/P) is of 0.466≦c_{<}1.327, wherein a is the width of the opening of the slit, S is the distance from the center position of lens conjugation length to the slit, P is a lens pitch of the lens array, and D is the lens diameter of an inner lens of the lens array,

the value of P/D is of 1.180≦P/D<2.157,

the value of DL/P is of 0.7≦DL/P<0.950, wherein DL is the lens diameter of an outer lens of the lens array, and

the value of e=(h/DM)×tan θ×(P/1.25D) is of 0.062≦e, wherein h is the height of the light-shielding wall and DM=(DL+D)/2.

29. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the object plane,

the view angle θ of a lens of the lens array is of 0°<θ≦21°,

the value of P/D is of 1.034≦P/D, in particular, 1.142≦P/D for 0°<θ<6.12°, wherein P is a lens pitch of the lens array, D is the lens diameter of an inner lens of the lens array, and DL is the lens diameter of an outer lens of the lens array, and the value of e=(h/DM)×tan θ×(P/1.25D) is of 0.479≦e, wherein h is the height of the light-shielding wall and DM=(DL+D)/2.

30. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the object plane,

the view angle θ of a lens of the lens array is of 0°<θ≦21°,

the value of P/D is of 1.034≦P/D, in particular, 1.142≦P/D for 0°<θ<9°, and 1.180≦P/D for 9°≦θ<21, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.498≦e, wherein h is the height of the light-shielding wall and DM=(DL+D)/2.

31. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the object plane,

the view angle θ of a lens of the lens array is 0° of <θ≦21°,

the value of P/D is of 1.142≦/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.479≦e, wherein h is the height of the light-shielding wall and DM=(DL+D)/2.

32. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the object plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.4985≦e, wherein h is the height of the light-shielding wall and DM=(DL+D)/2.

33. An imaging optical system according to any one of items 29-32, wherein

the value of P/D is of 1.678>P/D, and

the value of DL/P is of 0.750≦DL/P.

34. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the image reading plane or the image writing plane,

the view angle θ of a lens of the lens array is of 0°<θ≦21°,

the value of P/D is of 1.0344≦P/D, in particular, 1.142≦P/D for 0°<θ<6.12°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.479≦e, wherein h is the height of the light-shielding wall and DM=(DL+D)/2.

35. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the image reading plane or the image writing plane,

the view angle θ of a lens of the lens array is of 0°<θ≦21°,

the value of P/D is of 1.034≦P/D, in particular, 1.142≦P/D for 0°<θ<9°, and 1.180≦P/D for 9°≦θ<21, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.498≦e, wherein h is the height of the light-shielding wall and DM=(DL+D)/2.

36. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the image reading plane or the image writing plane,

the view angle θ of a lens of the lens array is of 0°<θ≦21°,

the value of P/D is of 1.142≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.479≦e, wherein h is the height of the light-shielding wall and DM=(DL+D)/2.

37. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only on the lens array plate on the side of the image reading plane or the image writing plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.498≦e, wherein h is the height of the light-shielding wall and DM=(DL+D)/2.

38. An imaging optical system according to any one of items 34-37, wherein the value of z/TC is of 0.245≦z/TC, wherein z is he thickness of a lens of the lens array and TC is the conjugation length of a lens of the lens array,

the value of P/D is of 1.678>P/D, and

the value of DL/P is of 0.750≦DL/P.

39. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided on the lens array on the side of the object plane and on the lens array on the side of the image reading plane or the image writing plane,

the view angle θ of a lens of the lens array is of 0°<θ≦21°,

the value of P/D is of 1.034≦P/D, in particular, 1.142≦P/D for 0°<θ<6.12°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.287≦e, wherein h is the height of the light-shielding wall and DM=(DL+D)/2.

40. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided on the lens array on the side of the object plane and on the lens array on the side of the image reading plane or the image writing plane,

the view angle θ of a lens of the lens array is of 0°<θ≦21°,

the value of P/D is of 1.034≦P/D, in particular, 1.142≦P/D for 0°<θ≦9°, and 1.180≦P/D for 9°≦θ<21°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.307≦e, wherein h is the height of the light-shielding wall and DM=(DL+D)/2.

41. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided on the lens array on the side of the object plane and on the lens array on the side of the image reading plane or the image writing plane,

the view angle θ of a lens of the lens array is of 0°<θ≦21°,

the value of P/D is of 1.142≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.287≦e, wherein h is the height of the light-shielding wall and DM=(DL+D)/2.

42. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided on the lens array on the side of the object plane and on the lens array on the side of the image reading plane or the image writing plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.307≦e, wherein h is the height of the light-shielding wall and DM=(DL+D)/2.

43. An imaging optical system according to any one of items 39-42, wherein

the value of P/D is of 1.678>P/D,

the value of e is of 0.574>e, and

the value of DL/P is of 0.750≦DL/P.

44. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that the light-shielding wall is provided only inside the lens array on the side of the object plane,

the view angle θ of a lens of the lens array is of 0°<θ≦21°,

the value of P/D is of 1.034≦P/D, in particular, 1.142≦P/D for 0°<θ<6.12°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.347≦e, wherein h is the height of the light-shielding wall and DM=(DL+D)/2.

45. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that the light-shielding wall is provided only inside the lens array on the side of the object plane,

the view angle θ of a lens of the lens array is of 0°<θ≦21°,

the value of P/D is of 1.034≦P/D, in particular, 1.142≦P/D for 0°<θ<9°, and 1.180≦P/D for 9°≦θ<21°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.384≦e, wherein h is the height of the light-shielding wall and DM=(DL+D)/2.

46. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that the light-shielding wall is provided only inside the lens array on the side of the object plane,

the view angle θ of a lens of the lens array is of 0°<θ≦21°,

the value of P/D is of 1.142≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.347≦e, wherein h is the height of the light-shielding wall and DM=(DL+D)/2.

47. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only inside the lens array on the side of the object plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.384≦e, wherein h is the height of the light-shielding wall and DM=(DL+D)/2.

48. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only inside the lens array on the side of the image reading plane or the image writing plane,

the view angle θ of a lens of the lens array is of 0°<θ≦21°,

the value of P/D is of 1.034≦T/D, in particular, 1.142≦P/D for 0°<θ<6.12°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.307≦e, wherein h is the height of the light-shielding wall and DM=(DL+D)/2.

49. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that the light-shielding wall is provided only inside the lens array on the side of the image reading plane or the image writing plane,

the view angle θ of a lens of the lens array is of 0°<θ≦21°,

the value of P/D is of 1.034≦P/D, in particular, 1.142≦P/D for 0°<θ<9°, and 1.180≦P/D for 9°≦θ<21°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.326≦e, wherein h is the height of the light-shielding wall and DM=(DL+D)/2.

50. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that the light-shielding wall is provided only inside the lens array on the side of the image reading plane or the image writing plane,

the view angle θ of a lens of the lens array is of 0°<θ≦21°,

the value of P/D is of 1.142≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.307≦e, wherein h is the height of the light-shielding wall and DM=(DL+D)/2.

51. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding wall is provided only inside the lens array on the side of the image reading plane or the image writing plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.326≦e, wherein h is the height of the light-shielding wall and DM=(DL+D)/2.

52. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided inside the lens array on the side of the object plane and inside the lens array on the side of the image reading plane or the image writing plane,

the view angle θ of a lens of the lens array is of 0°<θ≦21°,

the value of P/D is of 1.034≦P/D, in particular, 1.142≦P/D for 0°<θ<6.12°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0<e, wherein h is the height of the light-shielding wall and DM=(DL+D)/2.

53. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided inside the lens array on the side of the object plane and inside the lens array on the side of the image reading plane or the image writing plane,

the view angle θ of a lens of the lens array is of 0°<θ≦21°,

the value of P/D is of 1.034≦P/D, in particular, 1.142≦P/D for 0°<θ<9°, and 1.180≦P/D for 9°≦θ<21°, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.287≦e, wherein h is the height of the light-shielding wall and DM=(DL+D)/2.

54. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided inside the lens array on the side of the object plane and inside the lens array on the side of the image reading plane or the image writing plane,

the view angle θ of a lens of the lens array is of 0°<θ≦21°,

the value of P/D is of 1.142≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0<e, wherein h is the height of the light-shielding wall and DM=(DL+D)/2.

55. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that

the light-shielding walls are provided inside the lens array on the side of the object plane and inside the lens array on the side of the image reading plane or the image writing plane,

the view angle θ of a lens of the lens array is of 0°<θ≦21°,

the value of P/D is of 1.180≦P/D, wherein P is a lens pitch of the lens array, D is the lens diameter of an inner lens of the lens array, and DL is the lens diameter of an outer lens of the lens array, and

the value of e=(h/DM)×tan θ×(P/1.25D) is of 0.287≦e, wherein h is the height of the light-shielding wall and DM=(DL+D)/2.

56. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding wall is provided only on the lens array on the side of the object plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°xy°/15° for 0°<θ<3°, and 10°×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array, the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.087≦e for 0°<θ<6.12°, and 0.039≦e for 6.12°≦θ<9°, wherein h is the height of the light-shielding wall and DM=(DL+D)/2.

57. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding wall is provided only on the lens array on the side of the image reading plane or the image writing plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array, the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.018≦e for 0°<θ<6.12°, and 0.048≦e for 6.12°≦θ<9°, wherein h is the height of the light-shielding wall and DM=(DL+D)/2.

58. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding walls are provided on the lens array plate on the side of the image reading plane or the image writing plane and on the lens array plate on the side of the object plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10′×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array, the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.066≦e for 0°<θ<6.12°, and 0.03≦e for 6.12′θ<9°, wherein h is the height of the light-shielding wall and DM=(DL+D)/2.

59. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding wall is provided only inside the lens array plate on the side of the object plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

60. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding wall is provided only inside the lens array plate on the side of the image reading plane or the image reading plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°φ≦27°×y°/15°, in particular, 11°×y°/15°≦φ<17°×y°/15° for 0°<θ<3°, and 10°×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array, the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

61. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that

the light-shielding walls provided inside the lens array plate on the side of the object plane and inside the lens array plate on the side of the image reading plane or the image writing plane,

the view angle θ of a lens of the lens array is of 0°<θ≦21°,

y°=−0.006630x²+0.809473x−9.700729 is defined, wherein x is the angle between adjacent lens arrangement directions of the lens array,

the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,

the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,

the value of P/D is of 1.034≦P/D<2.157, in particular, 1.142≦P/D<2.157 for 0°<θ<6.12°,

the value of DL/P is of 0.7≦DL/P<0.950, wherein DL is the lens diameter of an outer lens of the lens array, and

the value of e=(h/DM)×tan θ×(P/1.25D) is 0<e, in particular, 0.062≦e for 0°<θ<6.12°, and 0.028≦e for 6.12°≦θ<9°, wherein h is the height of the light-shielding wall and DM=(DL+D)/2.

62. An imaging optical system according to any one of items 1-61, wherein the lens array is comprised of at least two lens plates on both surfaces of each thereof lenses are arranged, and the lens forming area is formed at least at one side of each lens plate.

63. An imaging optical system according to any one of items 1-61, wherein the lens array is comprised of at least two lens plates on both surfaces of each thereof lenses are arranged, and at least one edge of each lens plate at least on the side of the object plane is cut off.

64. An imaging optical system according to any one of items 1-61, wherein the optical absorptance of the light-shielding wall is in a range of 50-100%.

65. An imaging optical system according to any one of items 1-61, wherein the optical absorptance of the light-shielding wall is in a range of 95-100%.

66. An imaging optical system according to any one of items 1-61, wherein the optical absorptance of the light-shielding wall is 90% or more and the surface roughness Ra of the light-shielding wall is 10 nm or more.

67. An imaging optical system according to any one of items 1-61, wherein the optical absorptance of the light-shielding wall is 90% or more and the surface roughness Ra of the light-shielding wall is 5 nm or more.

68. An imaging optical system according to any one of items 1-61, wherein the optical absorptance of the light-shielding wall is 0% or more and the surface roughness Ra of the light-shielding wall is 500 nm or more.

69. An imaging optical system according to any one of items 1-61, wherein the diameter D of the inner lens is of D=Z×θ, wherein z is the thickness of a lens of the lens array.

70. An image reading apparatus comprising an imaging optical system defined in any one of items 1-69.

71. An image writing apparatus comprising an imaging optical system defined in any one of items 1-69.

72. An image reading apparatus comprising an imaging optical system according to item 70, wherein a sensor array substrate on which a sensor array is mounted is provided at the image reading plane, and the color of the image sensor substrate is a low brightness color.

### INDUSYTRIAL APPLICABILITY

An imaging optical system in accordance with the present invention has advantageous effects such that the ghost is suppressed, the brightness is high, and the unevenness of the amount of light is small, so that the system may be applicable to an imaging optical system and an image writing apparatus.

1. An imaging optical system comprising an object plane, a lens array for transmitting the light from the object plane, an image reading plane or an image writing plane arranged at an imaging position of the light transmitted through the lens array, a light-shielding wall provided at the lens array, and a slit arranged between the object plane and the lens array, characterized in that
the lens arrangement direction of the lens array is different from the direction of the longitudinal edge of a lens forming area of the lens array.

2. An imaging optical system according to claim 1, wherein
the lens arrangement of the lens array is hexagonal arrangement,
the light-shielding wall is provided only on the lens array on the side of the object plane, the view angle θ of a lens of the lens array is of 0°<θ≦21°,
the angle φ at which the lens arrangement direction of the lens array is inclined with the direction of the longitudinal edge of the lens forming area of the lens array is of 11°<φ≦25°, in particular, 11°≦φ<17° for 0°<θ<6.12°, and 12°≦φ<17° for 6.12°≦θ<9°,
the value of c={a/(2S×tan 2θ×sin 15°)}×(1.25D/P) is of 0.466≦c_{<}1.492, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D_{<}2.157, in particular, 1.142≦P/D<2.157 for 0°<θ<9°, and 1.180≦P/D<2.157 for 9°≦θ<21°,
the value of DL/P is of 0.7≦L/P<0.950, wherein DL is the lens diameter of an outer lens of the lens array, and
the value of e=(h/DM)×tan θ×(P/1.25D) is of 0.057≦e, in particular, 0.087≦e for 0°<θ<6.12°, and 0.077≦e for 9°≦θ<21°, wherein h is the height of the light-shielding wall and DM=(DL+D)/2.

3. An imaging optical system according to claim 1, wherein
the lens arrangement of the lens array is hexagonal arrangement,
the light-shielding wall is provided only on the lens array on the side of the image reading plane or the image writing plane,
the view angle θ of a lens of the lens array is of 0°<θ≦21°,
the angle Φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.108≦e for 0°θ<6.12°, and 0.048≦e for 6.12°≦θ<9°, wherein h is the height of the light-shielding wall and DM=(DL+D)/2.

4. An imaging optical system according to claim 1, wherein
the lens arrangement of the lens array is hexagonal arrangement,
the light-shielding walls are provided on the lens array on the side of the image reading plane or the image writing plane and on the lens array on the side of the object plane,
the view angle θ of a lens of the lens array is of 0°<θ≦21°,
the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,
the value of c={a/(2S×tan 2θ×sin 15°)}×(1.25D/P) is of 0.466≦c_{<}1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.066≦e for 0°<θ<6.12°, and 0.03≦e for 6.12°≦θ<9°, wherein h is the height of the light-shielding wall and DM=(DL+D)/2.

5. An imaging optical system according to claim 1, wherein
the lens arrangement of the lens array is hexagonal arrangement,
the light-shielding wall is provided only inside the lens array plate on the side of the object plane,
the view angle θ of a lens of the lens array is of 0°<θ≦21°,
the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

6. An imaging optical system according to claim 1, wherein
the lens arrangement of the lens array is hexagonal arrangement,
the light-shielding wall is provided only inside the lens array plate on the side of the image reading plane or the image writing plane,
the view angle θ of a lens of the lens array is of 0°<θ≦21°,
the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

7. An imaging optical system according to claim 1, wherein
the lens arrangement of the lens array is hexagonal arrangement,
the light-shielding walls are provided inside the lens array plate on the side of the object plane and inside the lens array plate on the side of the image reading plane or the image writing plane,
the view angle θ of a lens of the lens array is of 0°<θ≦21°,
the angle φ at which the lens arrangement direction of the lens array is inclined with the direction of the longitudinal edge of the lens forming area of the lens array is of 9°<φ≦27°, in particular, 11°≦φ<17° for 0°<θ<3°, and 10°≦φ<16° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.062≦e for 0°<θ<6.12°, and 0.028≦e for 6.12°≦θ<9°, wherein h is the height of the light-shielding wall and DM=(DL+D)/2.

8. An imaging optical system comprising an object plane, a lens array for transmitting the light from the object plane, an image reading plane or an image writing plane arranged at an imaging position of the light transmitted through the lens array, and a light-shielding wall provided at the lens array, characterized in that
the value of e=(h/DM)×tan θ×(P/1.25D) is of 0≦e, wherein P is a lens pitch of the lens array, D is the lens diameter of an inner lens of the lens array, and DL is the lens diameter of an outer lens of the lens array, h is the height of the light-shielding wall, and DM=(DL+D)/2.

9. An imaging optical system according to claim 8, wherein
the light-shielding wall is provided only on the lens array on the side of the object plane,
the view angle θ of a lens of the lens array is 0°<θ≦21°,
the value of P/D is of 1.034≦P/D, in particular, 1.142≦P/D for 0°θ<6.12°, and
the value of e is of 0.479≦e.

10. An imaging optical system according to claim 8, wherein
the light-shielding wall is provided only on the lens array plate on the side of the image reading plane or the image writing plane,
the view angle θ of a lens of the lens array is of 0°<θ≦21°,
the value of P/D is of 1.034≦P/D, in particular, 1.142≦P/D for 0°<θ<6.12°, and
the value of e is of 0.479≦e.

11. An imaging optical system according to claim 8, wherein
the light-shielding walls are provided on the lens array on the side of the object plane, and on the lens array on the side of the image reading plane or the image writing plane,
the view angle θ of a lens of the lens array is of 0°<θ≦21°,
the value of P/D is of 1.034≦P/D, in particular, 1.142≦P/D for 0°<θ<6.12°, and
the value of e is of 0.287≦e.

12. An imaging optical system according to claim 8, wherein
the light-shielding wall is provided only inside the lens array on the side of the object plane,
the view angle θ of a lens of the lens array is of 0°<θ≦21°,
the value of P/D is of 1.034≦P/D, in particular, 1.142≦P/D for 0°<θ<6.12°, and
the value of e is of 0.347≦e.

13. An imaging optical system according to claim 8, wherein
the light-shielding wall is provided only inside the lens array on the side of the image reading plane or the image writing plane,
the view angle θ of a lens of the lens array is of 0°<θ≦21°,
the value of P/D is of 1.034≦P/D, in particular, 1.142≦P/D for 0°<θ<6.12°, and
the value of e is of 0.307≦e.

14. An imaging optical system according to claim 8, wherein
the light-shielding walls are provided inside the lens array on the side of the object plane and inside the lens array on the side of the image reading plane or the image writing plane,
the view angle θ of a lens of the lens array is of 0°<θ≦21°,
the value of P/D is of 1.034≦P/D, in particular, 1.142≦P/D for 0°<θ<6.12°, and
the value of e is of 0<e.

15. An imaging optical system according to claim 1, wherein
the light-shielding wall is provided only on the lens array on the side of the object plane,
the view angle θ of a lens of the lens array is of 0°<θ≦21°,
r=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of a lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.087≦e for 0°<θ<6.12°, and 0.039≦e for 6.12°≦θ<9°, wherein h is the height of the light-shielding wall and DM=(DL+D)/2.

16. An imaging optical system according to claim 1, wherein
the light-shielding wall is provided only on the lens array on the side of the image reading plane or the image writing plane,
the view angle θ of a lens of the lens array is of 0°<θ≦21°,
y°=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of the lens forming area of the lens array is of 9°×y°/15°≦φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.018≦e for 0°<θ<6.12°, and 0.048≦e for 6.12°≦θ<9°, wherein h is the height of the light-shielding wall and DM=(DL+D)/2.

17. An imaging optical system according to claim 1, wherein
the light-shielding walls are provided on the lens array plate on the side of the image reading plane or the image reading plane and on the lens array plate on the side of the object plane,
the view angle θ of a lens of the lens array is of 0°<θ≦21°,
y°=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.066≦e for 0°<θ<6.12°, and 0.03≦e for 6.12°≦θ<9°, wherein h is the height of the light-shielding wall and DM=(DL+D)/2.

18. An imaging optical system according to claim 1, wherein
the light-shielding wall is provided only inside the lens array plate on the side of the object plane,
the view angle θ of a lens of the lens array is of 0°<θ≦21°,
y°=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

19. An imaging optical system according to claim 1, wherein
the light-shielding wall is provided only inside the lens array plate on the side of the image reading plane or the image reading plane,
the view angle θ of a lens of the lens array is of 0°<θ≦21°,
y°=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.4665≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is of 0<e, in particular, 0.071≦e for 0°<θ<6.12°, and 0.031≦e for 6.12°≦θ<9°, wherein h is the height of the light-shielding wall and DM=(DL+D)/2.

20. An imaging optical system according to claim 1, wherein
the light-shielding walls provided inside the lens array plate on the side of the object plane and inside the lens array plate on the side of the image reading plane or the image writing plane,
the view angle θ of a lens of the lens array is of 0°<θ≦21°,
y°=−0.006630x²+0.809473x−9.700729 is defined, wherein x is the angle between adjacent lens arrangement directions of the lens array,
the angle φ at which the lens arrangement direction of the lens array is inclined with the direction of the longitudinal edge of the lens forming area of the lens array is of 9°×y°/15°<φ≦27°×y°/15°, in particular, 11°×y°/15°≦φ<17°×y°/15° for 0°<θ<3°, and 10°×y°/15°≦φ<16°×y°/15° for 3°≦θ<9°,
the value of c={a/(2S×tan 2θ×sin 15°)}×(1.25D/P) is of 0.466≦c<1.767, in particular, 0.466≦c<1.492 for 0°<θ<6.12°, wherein a is the width of the opening of the slit, S is the distance from the center position of lens conjugation length to the slit, P is a lens pitch of the lens array, and D is the lens diameter of an inner lens of the lens array,
the value of P/D is of 1.034≦P/D<2.157, in particular, 1.142≦P/D<2.157 for 0°<θ<6.12°,
the value of DL/P is of 0.7≦DL/P<0.950, wherein DL is the lens diameter of an outer lens of the lens array, and
the value of e=(h/DM)×tan θ×(P/1.25D) is 0<e, in particular, 0.062≦e for 0°<θ<6.12°, and 0.028≦e for 6.12°≦θ<9°, wherein h is the height of the light-shielding wall and DM=(DL+D)/2.

21. (canceled)

22. (canceled)

23. (canceled)

24. (canceled)

25. (canceled)

26. (canceled)

27. (canceled)

28. (canceled)

29. (canceled)
